(19) United States
(12) Patent Application Publication
(10) Pub. No.: US 2013/0195272 A1
(43) Pub. Date: Aug. 1, 2013

(54) BASE STATION APPARATUS FOR TRANSMITTING OR RECEIVING A SIGNAL CONTAINING PREDETERMINED INFORMATION

(71) Applicant: SANYO Electric Co., Ltd., Osaka (JP)

(72) Inventors: Makoto NAGAI, Kakamigahara-city (JP); Yoshihiro HORI, Gifu-city (JP)

(73) Assignee: SANYO ELECTRIC CO., LTD., Osaka (JP)

(21) Appl. No.: 13/680,918

(22) Filed: Nov. 19, 2012

Related U.S. Application Data
(63) Continuation of application No. PCT/JP2011/002806, filed on May 16, 2011.

(30) Foreign Application Priority Data
May 19, 2010 (JP) 2010-115839
May 31, 2010 (JP) 2010-124968

(51) Int. Cl. H04L 29/06

(52) U.S. Cl. CPC H04L 63/06
USPC 380/259

(57) ABSTRACT

A storage unit stores a symmetric key table that indicates a plurality of kinds of symmetric keys usable for the communications between terminal apparatuses. A MAC frame processing unit receives a packet broadcast from the terminal apparatus. A verification unit verifies the version of the symmetric key table containing a symmetric key by which to generate a digital signature appended to the received packet. A detector detects that the version of the symmetric key table verified is older than the version of the symmetric key table stored in the storage unit. When the number of detections is a predetermined number or above in a unit time, the MAC frame processing unit generate a packet that stores the symmetric key table stored in the storage unit. The MAC frame processing unit broadcasts the packet generated.

### BACKGROUND OF THE INVENTION

1. Field of the Invention

The present invention relates to a communication technology, and it particularly relates to a base station apparatus for transmitting or receiving a signal containing predetermined information.

2. Description of the Related Art

A drive assist system has been under investigation. This drive assist system provides road information gained through a road-to-vehicle communication in an effort to prevent collision accidents of vehicles on a sudden encounter at an intersection and relieve the traffic jam or provides intersection information. Also, the drive assist system mutually provides driving information on vehicles through an inter-vehicle communication. In the road-to-vehicle communication, information on conditions at an intersection is communicated between a roadside unit and an in-vehicle unit. Such a road-to-vehicle communication requires installation of roadside units in an intersection or roadside, which means a great cost of time and money. In contrast to this, the inter-vehicular communication, in which information is communicated between in-vehicle units, has no need for installation of roadside units. In that case, current position information is detected in real time by GPS (Global Positioning System) or the like and the positional information is exchanged between the in-vehicle units. Thus it is determined on which of the roads leading to the intersection the driver's vehicle and the other vehicles are located.

The wireless communications are more susceptible to the interception of communications than the wired communications and therefore the wireless communications have difficulty in ensuring the secrecy of communication contents. Also, when equipment is to be controlled remotely via a network, an unauthorized action may possibly be taken by a fake third party. In order to secure the secrecy of communication contents in the wireless communications, it is required that the communication data be encrypted and the keys used for encryption be updated on a regular basis. When an encryption key is to be updated, network apparatuses are each, for example, in an initial state where only data encrypted with an old encryption key prior to the updating can be transmitted and received.

Then, each apparatus transmits from this initial state to a state where data encrypted with both the old encryption key and a newly updated encryption key can be transmitted and where the operation thereof is unknown as to the transmission and the receiving of data encrypted with the new encryption key. Further, each apparatus transits to a state where the data encrypted with both the old encryption key and the new encryption can be transmitted and received and where the operation concerning the transmission and the receiving of the data encrypted with the new encryption key has been determined. Finally, each apparatus transmits in sequence to a state where only data encrypted with the new encryption key after the completion of the updating of the key can be transmitted and received.

When a wireless LAN is applied to the inter-vehicular communication, a need arises to transmit information to a large indefinite number of terminal apparatuses, and therefore it is desirable that signals be sent by broadcast. Yet, at an intersection or like places, an increase in the number of vehicles, that is, the number of terminal apparatuses, is considered to cause an increase in the collisions of the packets therefrom. In consequence, data contained in the packets may not be transmitted to the other terminal apparatuses. If such a condition occurs in the inter-vehicular communication, then the objective of preventing collision accidents of vehicles on a sudden encounter at an intersection will not be attained. Further, when the road-to-vehicle communication is performed in addition to the inter-vehicular communication, the mode of communication becomes diversified. In such a case, it is required that the mutual effect between the road-to-vehicle communication and the inter-vehicular communication be reduced.

When the key for encryption is to be updated, the transition of a plurality of states used to be easy because the unicast communication was premised. When the broadcast communication is to be used, it is difficult to use a common encryption key if there are terminal apparatuses of different states. Although the traffic increases for the purpose of distributing a new encryption key, it is desired that the deterioration of frequency usage efficiency be suppressed. While there are terminal apparatuses that can use the new encryption key, there are those which cannot use the new encryption key. As a result, it is difficult to have a new encryption key used by and applicable to all of the terminal apparatuses. At the same time, a new encryption key is desirable for the improvement of the security of the communication system.

### SUMMARY OF THE INVENTION

The present invention has been made in view of the foregoing circumstances, and a purpose thereof is to provide a technology of using an encryption key suited to the broadcast communications.

A base station apparatus according to one embodiment of the present invention is a base station apparatus for controlling communications between terminal apparatuses each of which is to broadcast a packet to which a digital signature generated by a symmetric key in a symmetric key cryptosystem is appended, and the base station apparatus includes: a storage unit configured to store a symmetric key table that indicates a plurality of kinds of symmetric keys usable for the communications between the terminal apparatuses; a receiver configured to receive the packet from a terminal apparatus; a verification unit configured to verify a version of the symmetric key table containing a symmetric key by which to generate the digital signature appended to the packet received by said receiver; a detector configured to perform detection processing of detecting that the version of the symmetric key table verified by said verification unit is older than the version of the symmetric key table stored in the storage unit; generator configured to generate a packet that stores the symmetric key table stored in the storage unit, when the number of detections by said detector is a predetermined number or above in a unit time; and a broadcasting unit configured to broadcast the packet generated by said generator.

Optional combinations of the aforementioned constituting elements, and implementations of the invention in the form of methods, apparatuses, systems, recording media, computer programs and so forth may also be practiced as additional modes of the present invention.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 shows a structure of a communication system according to an exemplary embodiment of the present invention.

FIG. 2 shows a base station apparatus shown in FIG. 1.

FIG. 3 shows a format of MAC frame stored in a packet defined in the communication system of FIG. 1.

FIG. 4 shows a format of secure frame stored in a MAC frame defined in the communication system of FIG. 1.

FIG. 5 shows a data structure of a symmetric key table stored in a storage unit shown in FIG. 2.

FIG. 6 shows a structure of a terminal apparatus mounted on a vehicle shown in FIG. 1.

FIG. 7 is a flowchart showing a procedure for transmitting packets in the base station apparatus of FIG. 2.

FIG. 8 is a flowchart showing a procedure for selecting a symmetric key in the base station apparatus of FIG. 2.

FIG. 9 is a flowchart showing a procedure for transmitting a symmetric key table in the base station apparatus of FIG. 2.

FIG. 10 is a flowchart showing a procedure for receiving packets in the base station apparatus of FIG. 2.

FIG. 11 is a flowchart showing a procedure for receiving packets in the terminal apparatus of FIG. 6.

FIG. 12 shows a structure of a communication system according to a modification of an exemplary embodiment of the present invention.

FIG. 13 shows a structure of a base station apparatus shown in FIG. 12.

FIG. 14 shows a format of MAC frame stored in a packet defined in the communication system of FIG. 12.

FIG. 15 shows a format of secure frame stored in a MAC frame defined in the communication system of FIG. 12.

FIG. 16 shows a data structure of a symmetric key table stored in a storage unit shown in FIG. 13.

FIG. 17 shows a structure of a terminal apparatus mounted on a vehicle shown in FIG. 12.

FIG. 18 is a flowchart showing a procedure for transmitting packets in the base station apparatus of FIG. 13.

FIG. 19 is a flowchart showing a procedure for selecting a symmetric key in the base station apparatus of FIG. 13.

FIG. 20 is a flowchart showing a procedure for receiving packets in the base station apparatus of FIG. 13.

FIG. 21 is a flowchart showing a procedure for receiving packets in the terminal apparatus of FIG. 17.

FIG. 22 is a flowchart showing a procedure for transmitting packets in the terminal apparatus of FIG. 17.

FIG. 23 is a flowchart showing a procedure for selecting a symmetric key in the terminal apparatus of FIG. 17.

FIG. 24 is a flowchart showing another procedure for transmitting packets in the base station apparatus of FIG. 17.

FIG. 25 is a flowchart showing another procedure for receiving packets in the terminal apparatus of FIG. 17.

### DETAILED DESCRIPTION OF THE INVENTION

The invention will now be described by reference to the preferred embodiments. This does not intend to limit the scope of the present invention, but to exemplify the invention.

The present invention will be outlined before it is explained in detail. Exemplary embodiments of the present invention relate to a communication system that carries out not only an inter-vehicular communication between terminal apparatuses mounted on vehicles but also a road-to-vehicle communication from a base station apparatus installed in an intersection and the like to the terminal apparatuses. As the inter-vehicular communication, a terminal apparatus transmits, by broadcast, a packet in which the information such as the traveling speed and position of the vehicle is stored (note that the transmission of packet(s) by broadcast is hereinafter called “broadcasting”, “being broadcast” or “by broadcast” also). And the other terminal apparatuses receive the packets and recognize the approach or the like of the vehicle based on the data. As the road-to-vehicle communication, a base station apparatus transmits, by broadcast, a packet in which the intersection information, the traffic jam information, the security information, and the like are stored. For simpler explanation, the information contained in the packet used for the inter-vehicular communication and the road-to-vehicle communication will be hereinafter generically referred to as “data”.

The intersection information includes information on conditions at an intersection such as the position of the intersection, images captured of the intersection, where the base station apparatus is installed, and positional information on vehicles at or near the intersection. A terminal apparatus displays the intersection information on a monitor, recognizes the conditions of vehicles at or near the intersection based on the intersection information, and conveys to a user the presence of other vehicles and pedestrians for the purpose of preventing collision due to a right turn or a left turn at a sudden encounter at the intersection and the like so as to prevent the accidents. The traffic jam information includes information concerning the congestion situation near the intersection, where the base station apparatus is installed, and the information concerning road repairing and accidents that have happened. Based on such information, how much the road ahead may be congested is conveyed to the user or any possible detour is presented thereto. The security information includes information concerning the protection of data such as provision of a symmetric key table. Its detail will be discussed later.

To prevent the spoofing, use of a false identity and the like in such communications, digital signatures (digital signatures) are used. An encryption key is used to generate a digital signature. In the communication system according to the present embodiment, a symmetric key is used as an encryption key in consideration of the processing load. Also, a plurality of symmetric keys are used for the purpose of reducing the leakage risk of symmetric key. Each symmetric key is managed through each key ID. A plurality of symmetric keys are put altogether in a symmetric key table, and the version of the symmetric key table is managed through their table IDs. Further, each symmetric key in the key table is managed through the symmetric key ID. Accordingly, each key ID contains a table ID and a symmetric key ID. The encryption having defined in this manner, the spoofing can be prevented and the increase in the processing amount and the degradation in frequency usage efficiency are suppressed.

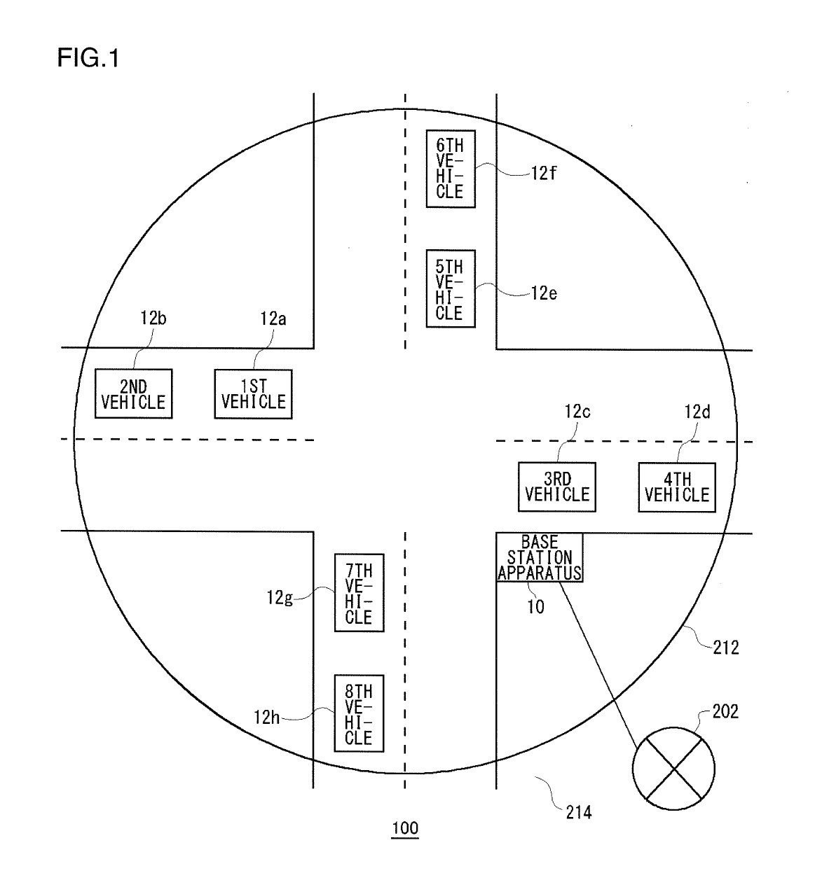

FIG. 1 shows a structure of a communication system 100 according to an exemplary embodiment of the present invention. FIG. 1 corresponds to a case thereof at an intersection viewed from above. The communication system 100 includes a base station apparatus 10, a first vehicle 12a, a second vehicle 12b, a third vehicle 12c, a fourth vehicle 12d, a fifth vehicle 12e, a sixth vehicle 12f, a seventh vehicle 12g, and an eighth vehicle 12h, which are generically referred to as “vehicle 12” or “vehicles 12”, and a network 202. It is to be noted that each vehicle 12 has a not-shown terminal apparatus installed therein.

As shown in FIG. 1, a road extending in the horizontal, or left-right, direction and a road extending in the vertical, or up-down, direction in FIG. 1 intersect with each other in the central portion thereof. Note here that the upper side of FIG. 1 corresponds to the north, the left side thereof the west, the down side thereof the south, and the right side thereof the east. And the portion where the two roads intersect each other is the intersection. The first vehicle 12a and the second vehicle 12b are advancing from left to right, while the third vehicle 12c and the fourth vehicle 12d are advancing from right to left. Also, the fifth vehicle 12e and the sixth vehicle 12f are advancing downward, while the seventh vehicle 12g and the eighth vehicle 12h are advancing upward.

A packet to which a digital signature generated with a symmetric key in a symmetric key cryptosystem is attached broadcasts in this communication system 100. The digital signature is a digital signature that is to be attached to an electromagnetic record such as data contained in the packet. This corresponds to a seal or signature in a paper document and is mainly used to authenticate a person's identity and to prevent the forgery and falsification. More specifically, when there is a person recorded in a document as a preparer of the document, whether the document is surely prepared by the person recorded in the document or not is certified, in the case of paper documents, by the signature or seal of the preparer. Since, however, the seal cannot be directly pressed against the electronic document or the signature cannot be written in the document, the digital signature serves its purpose of certifying this. To produce such digital signature, encryption is used.

A digital signature complying with a public key encryption scheme is effective as the digital signature. More specifically, RSA, DSA, ECDSA and the like are used as methods based on the public key encryption scheme. The digital signature scheme (digital signature scheme) is comprised of key generation algorithm, a signing algorithm, and a signature verifying algorithm. The key generation algorithm corresponds to an advance preparation of a digital signature. The key generation algorithm outputs a public key and a secret key (private key) of the user. A different random number is selected every time the key generation algorithm is executed and therefore a pair of a public key and a secret key is assigned to each user. Each user keeps the secret key, whereas the public key is open to the public. The public key is open to the public in the form of a public key certificate to which a digital signal is attached, wherein the public key certificate is certified by a certification authority (not shown), which is a third-party institution.

A user who has signed the signature is called an authorized signatory of a signed document. When a signatory is to prepare a signed document using a signing algorithm, the signatory enters its secret key (private key) together with messages. Since the secret key of the signatory is only known to the signatory himself/herself, the secret key serves itself as a means for identifying the preparer of the message to which the digital signature has been attached. A user, namely a verifier, who has received the message to which the public key certificate and the digital signature have been attached, verifies whether this signature is valid or not, by the use of the signature verifying algorithm. In so doing, the verifier enters the information of the received public key certificate and the public key issued by the certificate authority into the signature verifying algorithm so as to verify the public key of the signatory. The signature verifying algorithm determines whether the public key of the signatory is valid or not. As the validity has been determined, the verifier enters the message, to which the received signature has been attached, and the public key of the signatory into the signature verifying algorithm. The signature algorithm determines if the message has been surely prepared by the user and then outputs its result. Such the above-described arrangement for making the key public is called PKI (Public Key Infrastructure).

The processing load of such a public key encryption scheme is large in general. Near an intersection, for example, the packets sent from 500 terminal apparatuses 14 may have to be processed during 100 msec period, for example. Also, about 100 bytes of data are stored in the packets broadcast from the terminal apparatus mounted on the vehicle 12. In contrast to this, about 200 bytes are required for the public key certificate and the digital signature, so that the transmitting efficiency may be significantly reduced. Also, the amount of computation for the verification of a digital signature in the public key scheme is large. Accordingly, if the packets sent from 500 terminal apparatuses 14 are to be processed during 100 msec period, a sophisticated encryption computing apparatus or controller will be required, thereby increasing the cost of the terminal apparatuses. In order to cope with this problem, the digital signature with the symmetric key cryptosystem comes into service. In the symmetric key cryptosystem, the same key used for the encryption is used as a decryption key. Sharing a key in advance between a receiving side and a transmitting side is required in the symmetric key scheme. Thus, a decryption key is known to a receiving-side terminal apparatus and therefore the certificate of the key is no longer required. As a result, the degradation of transmission efficiency is suppressed as compared with when the public key encryption scheme is used. Also, the processing amount for the symmetric key cryptosystem is smaller than that for the public key encryption scheme. A typical method used for the symmetric key cryptosystem is DES and AES (Advanced Encryption standard). In the communication system 100, the symmetric key cryptosystem is used as the encryption scheme on account of the transmission load and the processing load. While the digital signature here is called the “digital signature with the public encryption scheme”, the symmetric key cryptosystem is called “message authentication”. In such a case, a message authentication code (MAC) is attached to the message instead of the signature. A typical method used for MAC is CBC-MAC (Cipher Block Chaining MAC).

As mentioned earlier, a plurality of symmetric keys are used for the purpose of reducing the leakage risk of symmetric key. In the communication system 100, the symmetric keys are adapted to the version upgrade of the symmetric keys managed through the table IDs. The symmetric keys are upgraded in a manner such that the base station apparatus 10 stores a new symmetric key table in the packets and then broadcasts the packets in which the new symmetric key table has been stored. Since an effective date/time and a period of validity are specified in the symmetric key table, the symmetric key table is broadcast before this new date/time goes into effect.

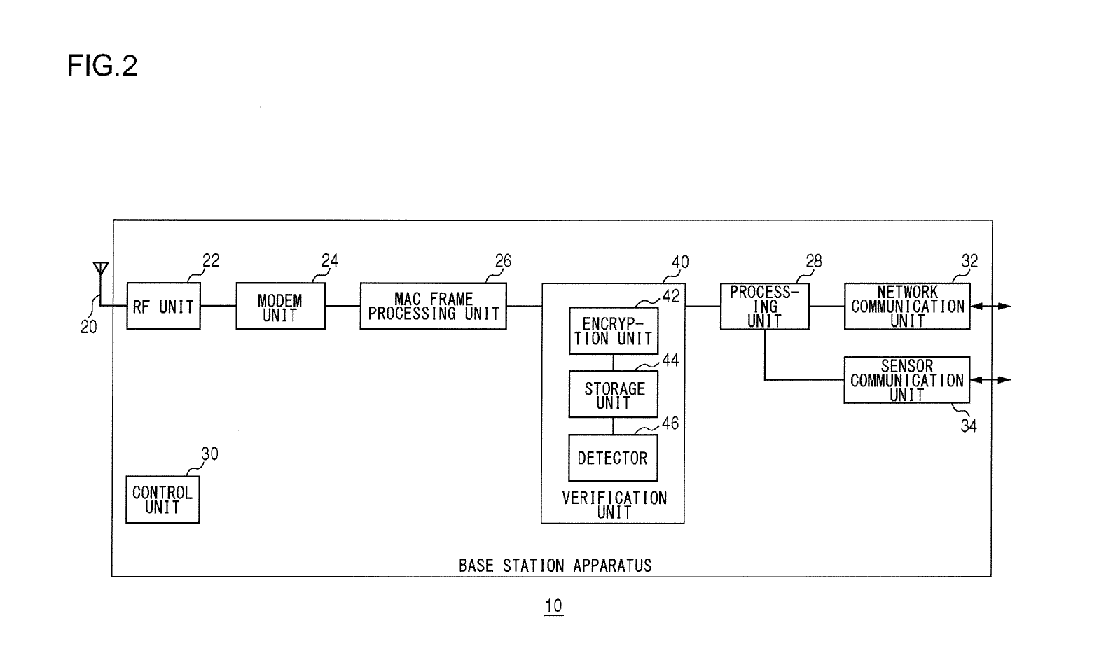

FIG. 2 shows the base station apparatus 10. The base station apparatus 10 includes an antenna 20, an RF unit 22, a modem unit 24, a MAC frame processing unit 26, a verification unit 40, a processing unit 28, a control unit 30, a network communication unit 32, and a sensor communication unit 34. The verification unit 40 includes an encryption unit 42, a storage unit 44, and a detector 46. The RF unit 22 receives, through the antenna 20, packets transmitted from terminal apparatuses and the other base station apparatuses (not shown), as a receiving processing. The RF unit 22 performs a frequency conversion on the received packet of a radiofrequency and thereby generates a packet of baseband. Further, the RF unit 22 outputs the baseband packet to the modem unit 24. Generally, a baseband packet is formed of an in-phase component and a quadrature component, and therefore the baseband packet should be represented by two signal lines. However, the baseband packet is here represented by a single signal line to make the illustration clearer for understanding. The RF unit 22 also includes an LNA (Low Noise Amplifier), a mixer, an AGC unit, and an A/D converter.

The RF unit 22 performs a frequency conversion on the baseband packet inputted from the modem unit 24 and thereby generates a radiofrequency packet as a transmission processing. Further, the RF unit 22 transmits, through the antenna 20, the radiofrequency packet in a road-to-vehicle transmission period. The RF unit 22 also includes a PA (Power Amplifier), a mixer, and a D-A converter.

The modem unit 24 demodulates the radiofrequency packet fed from the RF unit 22, as a receiving processing. Further, the modem unit 24 outputs a MAC frame obtained from the demodulation result, to the MAC frame processing unit 26. Also, the modem unit 24 modulates the data fed from the MAC frame processing unit 26, as a transmission processing. Also, the modem unit 24 modulates the MAC frame fed from the MAC frame processing unit 26, as a transmission processing. Further, the modem unit 24 outputs the modulation result to the RF unit 22 as a baseband packet. It is to be noted here that the communication system 100 is compatible with the OFDM (Orthogonal Frequency Division Multiplexing) modulation scheme and therefore the modem unit 24 performs FFT (Fast Fourier Transform) as a receiving processing and performs IFFT (Inverse Fast Fourier Transform) as a transmission processing also.

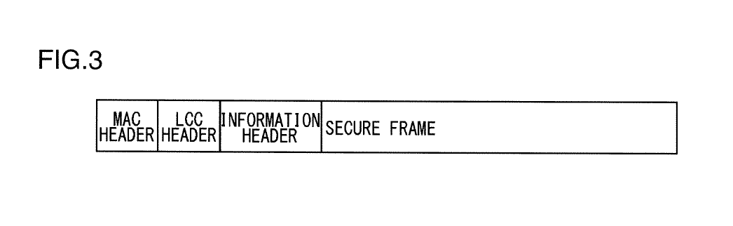

FIG. 3 shows a format of MAC frame stored in the packet defined in the communication system 100. Starting from the beginning, the MAC frame is constituted by “MAC header”, “LL header”, “information header”, and “secure header” in this order. Information concerning data communication control is stored in the MAC header, the LL header, and the information header, and the respective headers correspond to the respective layers of communication layer. Each feed length is as follows, for instance. The MAC header is of 30 bytes, the LLC header 8 bytes, and the information header 12 bytes. The secure frame will be discussed later. Now refer back to FIG. 2.

As a receiving processing, the MAC frame processing unit 26 retrieves the secure frame from the MAC frame fed from the modem unit 24 and outputs the secure frame to the verification unit 40. As a transmission processing, the MAC frame processing unit 26 adds the MAC header, the LLC header and the information header to the secure frame fed from the verification unit 40, generates a MAC frame, and outputs the MAC frame to the modem unit 24. Also, the timing control is performed so that the packets sent from the other base station apparatuses and terminal apparatuses do not collide with each other.

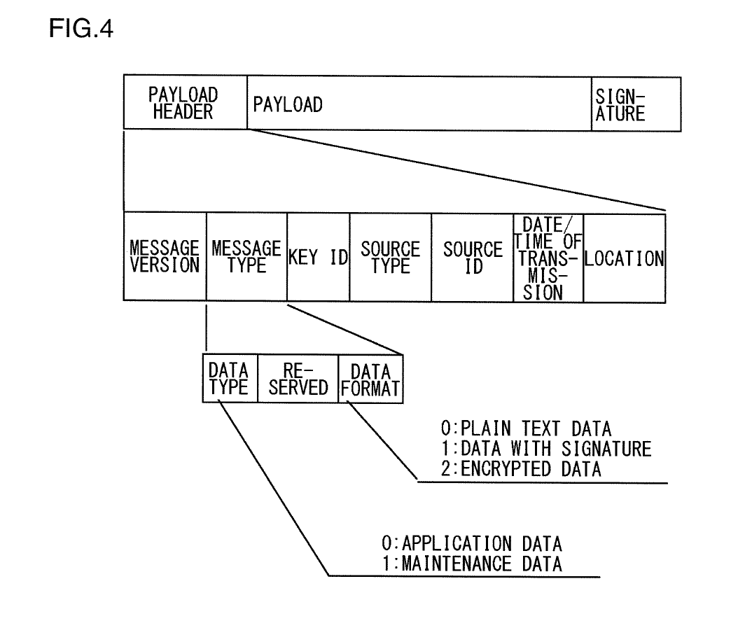

FIG. 4 shows a format of secure frame defined in the communication system 100. The secure frame is constituted by “payload header”, “payload”, and “signature”. The payload header is constituted by “message version”, “message type”, “key ID”, “source type”, “source ID”, “date/time of transmission”, and “location”. Message version is identification information by which to specify the format of a secure frame. The message version is a fixed value in the communication system 100. The message type includes “data type”, “data format”, and “reserve”. It is assumed herein that the data type sets the flag information defined as follows. The flag information identifies whether the data stored in the payload is application data (=0), namely data outputted to the subsequent MAC frame processing unit 26, or maintenance data (=1), namely secure information processed within the verification unit 40. In the communication system 100, the maintenance data is a symmetric key table. The data format is a format concerning the security of data stored in the payload, namely a flag that defines a process for encrypting the payload. Here, it is assumed that plaintext data (=0), data with signature (=1), and encrypted data (=2) are set. Note that “reserve” is a reserve for future use and will not be used by the communication system 100. The key ID is identification information by which a symmetric key used for the encryption of the digital signature or payload is identified, and is one for which the table ID and the symmetric key ID are connected. It is assumed herein that the source type ID sets the types of a sender of packets. That is, the source type ID sets is set to identify a base station apparatus 10 (=3), a terminal apparatus (=2) mounted on an emergency vehicle such as a fire-extinguishing vehicle and an ambulance vehicle (hereinafter referred to as “priority vehicle” also), a terminal apparatus (=1) mounted on other vehicles (hereinafter referred to as “ordinary vehicles” also), and a terminal apparatus (=0) mounted on a non-vehicle. The source ID is unique identification information by which a base station apparatus 10 or a terminal apparatus 14 that has transmitted the packet can be uniquely identified. The payload is a field that stores the aforementioned data, and corresponds to intersection information, road information and the like to be conveyed to the terminal apparatus. If the data format of the message type is data with signature (=1), the payload will be field that stores a digital signature for the payload header and the payload, namely a field that stores a MAC value. When the data format of the message type is encrypted data (=2), this data may be regarded as invalid. However, it is assumed herein that the digital signature is stored similarly to the case of a fixed value, a value identifiable at a receiving side, such as a copy of a payload header portion, or a hash value (a computational result for a hash function) for a payload header and/or a payload before encryption, a computable value at a receiving side, such as checksum and parity, or data with signature (=1). Then, the payload and the signature are encrypted as a whole. By so doing, if the value stored in the decrypted signature agrees with a value identified at the receiving side or a computed value, the decryption will be done normally and therefore the validity of data stored in the payload or data stored in the payload and payload header can be verified. Each feed length is as follows, for instance. That is, the payload header is of 32 bytes, the payload is of 100 bytes (if broadcast from a terminal apparatus) or of 1K bytes (if broadcast from a base station apparatus), and the signature is of 16 bytes, for instance. When the data format of the message type is data with signature, the digital signature is stored such that the MAC value evaluated by the CBC-MAC is stored in the signature. When the data format of the message type is encrypted data, the MAC value for the payload header is stored in the signature and then the payload and the signature are encrypted in a CBC mode. Note that when the MAC value is to be stored in the signature, the encryption may be performed in other encryption modes such as a counter mode. Now refer back to FIG. 2.

The verification unit 40 reads (interprets) the secure frame fed from the MAC frame processing unit 26 and outputs the data to the processing unit 28 as a receiving processing. Also, the verification unit 40 receives the data from the processing unit 28 and generates a secure frame and then outputs the secure frame to the MAC frame processing unit 26 as a transmission processing. Since the symmetric key cryptosystem is used in the communication system 100, the encryption unit 42 creates and verifies a digital signature and encrypts and decrypts the data with the symmetric key scheme. More specifically, when the message data type is data with signature, the digital signature is created at the time when the secure frame is created whereas the digital signature is verified at the time when the secure frame is read. Also, when the message data type is encrypted data, the encryption is done at the time when the secure frame is created whereas the data is decrypted at the time when the secure frame is read.

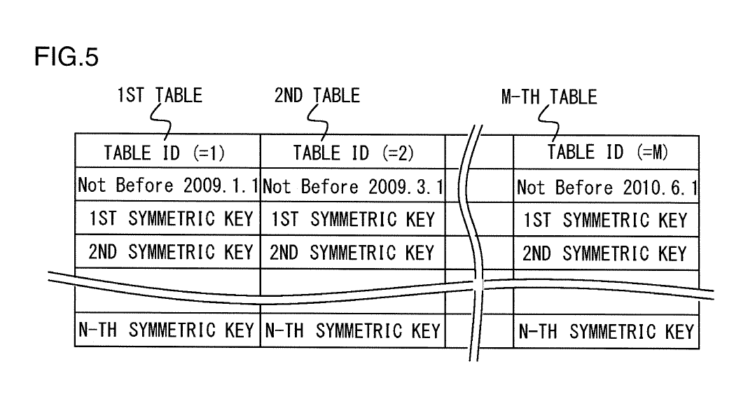

The storage unit 44 stores a symmetric key table holding a plurality of symmetric keys usable by the communication system 100. A plurality of different versions may be available for the symmetric key table. In such a case, they are managed through the table IDs. In FIG. 5, a first table corresponds to a case where its table ID is “1”. Similarly, a second table corresponds to a case where its table ID is “2”, and an Mth table corresponds to a case where its table ID is “M”. Each of the symmetric key tables contains a plurality of symmetric keys, and each of the symmetric keys is managed through the symmetric key ID. In FIG. 5, a first symmetric key corresponds to a case where the symmetric key ID is “1”, and a second symmetric key corresponds to a case where the symmetric key ID is “2”. Thus, a symmetric key is identified through the combination of a table ID and a symmetric key ID. Also, “NotBefore” with which to set up the effective date/time is provided in each symmetric key table. The effective date/time of the first table is “2009.1.1”. Similarly, the effective date/time of the second table is “2009.3.1”, and that of the Mth table is “2010.6.1”. If today's date is 2010.5.1 (May 1, 2010), the Mth table cannot be used. Note that the table IDs need not be in sequence. Note also that the symmetric key table may contain “NotAfter” (indicating the end of effective date/time or the period of validity). Now refer back to FIG. 2.

When generating the secure frame, the verification unit 40 extracts a symmetric key by referencing the storage unit 44. For example, the effective date/time is defined in each symmetric key table as “NotBefore”, and the MAC frame processing unit 26 selects a symmetric key table based on the present time. The verification unit 40 selects, from among the symmetric key tables in use, a most current symmetric key table whose effective date/time indicated in “NotBefore” is the latest. Further, the verification unit 40 selects a symmetric key in the selected symmetric key table. This selection may be made at random or according to the identification number assigned to the base station apparatus 10. If the data format of the message type is data with signature, the encryption unit 42 of the verification unit 40 will compute a digital signature for the payload header and the payload by the use of the selected symmetric key. If the data format of the message type is encrypted data, the payload and the signature will be encrypted by the encryption unit 42. If the data format of the message type is plaintext data, the verification unit 40 will output the generated secure frame to the MAC frame processing unit 26 as it is. If the secure frame is to be generated by the use of the data received from the MAC frame processing unit 26, the data type of the message type will be set to the application data (=0).

When reading the secure frame, the verification unit 40 references the key ID of the secure frame received from the MAC frame processing unit 26 and obtains a table ID and a symmetric key ID of a symmetric key to be used. Then, the verification unit 40 references the storage unit 44 and extracts a symmetric key identified by the table ID and the symmetric key ID. Further, if the data format of the message type of the secure frame received from the MAC frame processing unit 26 is data with signature, the verification unit 40 will use the extracted symmetric key and verify the validity of the signature. More precisely, the digital signature for the payload header and the payload is computed at the encryption unit 42, and the computed value is compared against the value of the digital signature stored in the signature of the secure frame received from the MAC frame processing unit 26. If the two values of the signatures agree with each other, it will be determined that the electronic signal is valid and that the information contained in the secure frame is information sent from a proper base station apparatus 10 or terminal apparatus 14, and the information will be outputted to the MAC frame processing unit 26. If the two values of the signatures do not agree with each other, it will be determined that the digital signature is not valid, and therefore the data will be discarded. Also, if the data format of the message type is encrypted data, the payload and the signature will be decrypted at the encryption unit 42. Then, if the signature has a predetermined value, it will be determined that the data extracted from the secure frame has been normally decrypted, and the data extracted from the secure frame will be outputted to the MAC frame processing unit 26. If, however, the signature does not have the predetermined value, the data will be discarded. The reason why an object to be encrypted is signature is as follows. It is because, as described earlier, a predetermined value is stored in the signature and is to be encrypted and therefore the signature has a function in which whether the decryption has been performed normally at decryption or not is checked. If such a check function as this is not to be implemented, there is no need to encrypt the signature. If the data format of the message type is plaintext data, the data extracted will be outputted to the MAC frame processing unit 26 without any preconditions. Although, in this exemplary embodiment, two digital signatures, which are the digital signature stored in the signature of the secure frame and the computed digital signature for the payload header and the payload, are compared with each other, this should not be considered as limiting. The digital signatures are verified according to the signature verifying algorithm of the digital signature scheme employed.

Further, the verification unit 40 generates a secure frame containing the symmetric key table stored in the storage unit 44. At this time, the data type of the message type is set to the maintenance data (=1). The symmetric key table stored in the storage unit 44 is to be broadcast before the effective date/time and will be broadcast after the effective date/time. The verification unit 40 selects a symmetric key table to which a table ID, indicating that said table is to be broadcast, is attached, and generates a secure frame in which the selected symmetric key table is stored. In this case, the data format of the message type is set to the encryption data. The thus generated secure frame is outputted to the MAC frame processing unit 26 as it is.

The detector 46 receives the digital signature, which has been determined to be valid at the verification unit 40, or the table ID of the symmetric key table used for the encryption. This corresponds to verifying the version information of the symmetric key table contained in the symmetric key used in the received packet. Also, the detector 46 may acquire the identification number of a terminal apparatus that has transmitted said packet.

The detector 46 compares the thus received table ID with the table ID of the most current symmetric key table stored in the storage unit 44. If the detector 46 detects that the table ID of the former does not agree with the table ID of the latter, the detector 46 will count the number of detections for each table ID. If any of the number of detections detected thereby is a predetermined number of times or above in a unit time, the detector 46 will determine the broadcasting of the latest symmetric key table. Here, the number of identification numbers for a terminal apparatus may also be counted. This is because the number of detections in the unit time is to be corrected in consideration of the case where a plurality of packets are received from the same terminal apparatus. Also, the determination may be made in consideration of a detection rate in a predetermined length of time.

As the broadcasting thereof is determined, the verification unit 40 generates a secure frame in which the symmetric key table to be broadcast, namely the latest symmetric key table in use, is encrypted with the symmetric key of the symmetric key table identified by the table ID for which the broadcasting has been determined after the counting, and then broadcasts the thus generated secure frame as a packet.

Although a symmetric key of the symmetric key table in use recorded in the storage unit 44 is used when the symmetric key table is broadcast, another symmetric key prepared for the broadcasting of the symmetric key table or the symmetric key table itself may be used instead. This corresponds to using a table master key. Also, the encryption may be performed with a symmetric key or public key sent from the terminal apparatus 14. In this case, the terminal apparatus 14 that can receive the symmetric key table is restricted to the terminal apparatus 14 that has transmitted the key used for the encryption. Further, the terminal apparatuses that are to transmit the symmetric key table may be restricted to a pre-selected one. For example, the symmetric key table is encrypted with the terminal ID with which to identify the terminal apparatus, in addition to a key of the symmetric key table used by the terminal apparatus or the table master key. As another example, not only a transmission key is encrypted with the terminal ID with which to identify the terminal apparatus but also the symmetric key table is encrypted with the transmission key, in addition to a key of the symmetric key table used by the terminal apparatus or the table master key. As a result, the transmission key and the symmetric key table encrypted with the transmission key are broadcast. Thereby, the communication cost and the processing load can be reduced even when the symmetric key table is transmitted individually.

The sensor communication unit 34 is connected to a not-shown internal network. Connected to the internal network are devices, for gathering the information on the intersections, such as a camera and a laser sensor (not shown) installed in each intersection. The devices, for gathering the information on the intersection, connected to the sensor communication unit 34 are generically referred to as “sensor” or “sensors”. The sensor communication unit 34 collects information obtained from the sensors installed in each intersection, via the network. The network communication unit 32 is connected to the not-shown network.

The processing unit 28 processes the data received from the verification unit 40. The processing result may be directly outputted to the network via the network communication unit 32 or may be accumulated internally and then outputted to the not-shown network at regular intervals. Also, the processing unit 28 generates data to be sent to the terminal apparatus 14, based on the road information (e.g., road repairing, congestion situation) received from the not-shown network via the network communication unit 32 and the information on the intersections gained from the not-shown sensors via the sensor communication unit 34. Also, upon receipt of a new symmetric key table via the network communication unit 32, the processing unit 28 writes the new symmetric key to the storage unit 44 of the verification unit 40 and conveys the period of time of the broadcasting to the verification unit 40. The control unit 30 controls the entire processing of the base station apparatus 10.

These structural components may be implemented hardwarewise by elements such as a CPU, memory and other LSIs of an arbitrary computer, and softwarewise by memory-loaded programs or the like. Depicted herein are functional blocks implemented by cooperation of hardware and software. Therefore, it will be obvious to those skilled in the art that the functional blocks may be implemented by a variety of manners including hardware only or a combination of both.

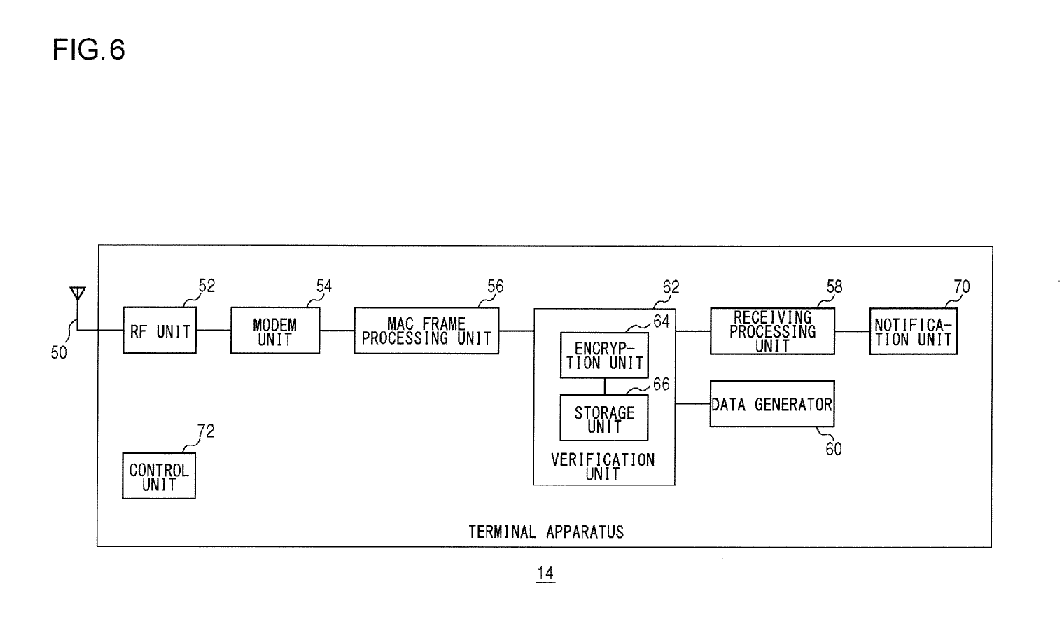

FIG. 6 shows a structure of a terminal apparatus 14 mounted on a vehicle 12. The terminal apparatus 14 includes an antenna 50, an RF unit 52, a modem unit 54, a MAC frame processing unit 56, a receiving processing unit 58, a data generator 60, a verification unit 62, a notification unit 70, and a control unit 72. The verification unit 62 includes an encryption unit 64 and a storage unit 66. The antenna 50, the RF unit 52, the modem unit 54, the MAC frame processing unit 56, the encryption unit 64, and the storage unit 66 perform the processings similar to those of the antenna 20, the RF unit 22, the modem unit 24, the MAC frame processing unit 26, the encryption unit 42, and the storage unit 44 of FIG. 2, respectively. Thus, the description of the similar processings thereto is omitted here and a description is given centering around features different from those of FIG. 2.

Similar to the verification unit 40, the verification unit 62 generates and reads (interprets) a secure frame. If the payload of the received secure frame is security information, namely if it contains a symmetric key table, and if the symmetric key table is not yet recorded in the storage unit 66, the verification unit 62 will have the storage unit 66 store the received symmetric key table therein. If there is free space in the storage unit 66, the received symmetric key table will be additionally recorded directly in the storage unit 66. If the storage unit 66 is full, a table whose effective date/time is the oldest in the symmetric key tables stored in the storage unit 66 will be rewritten by the received symmetric key table. Note that the verification unit 62 does not transmit the symmetric key table stored in the storage unit 66.

The receiving processing unit 58 estimates a crash risk, an approach of an emergency vehicle, such as a fire-extinguishing vehicle and an ambulance vehicle, a congestion situation in a road ahead and intersections, and the like, based on the data received from the verification unit 62 and the information on its vehicle received from the data generator 60. If the data is image information, the data will be processed so that it can be displayed by the notification unit 70.

The notification unit 70 includes notifying means such as a monitor, a lamp, and a speaker (not shown). The approach of other vehicles 12 (not shown) and the like are conveyed to a driver, via the monitor, the lamp and the speaker, according to instructions from the receiving processing unit 58. Also, the congestion information, the image information on the intersections and the like, and other information are displayed on the monitor.

The data generator 60 includes a GPS receiver, a gyroscope, a vehicle speed sensor, and so forth all of which are not shown in FIG. 6. The data generator 60 acquires information on the not-shown its vehicle, namely the present position, traveling direction, traveling speed and so forth of the vehicle 12 that are carrying the terminal apparatuses 14, based on the information supplied from the components of the data generator 60. The present position thereof is indicated by the latitude and longitude. Known art may be employed to acquire them and therefore the description thereof is omitted here. The data generator 60 generates data based on the acquired information, and outputs the generated data to the verification unit 62. Also, the acquired information is outputted to the receiving processing unit 58 as the information on its vehicle. The control unit 72 controls the entire operation of the terminal apparatus 14.

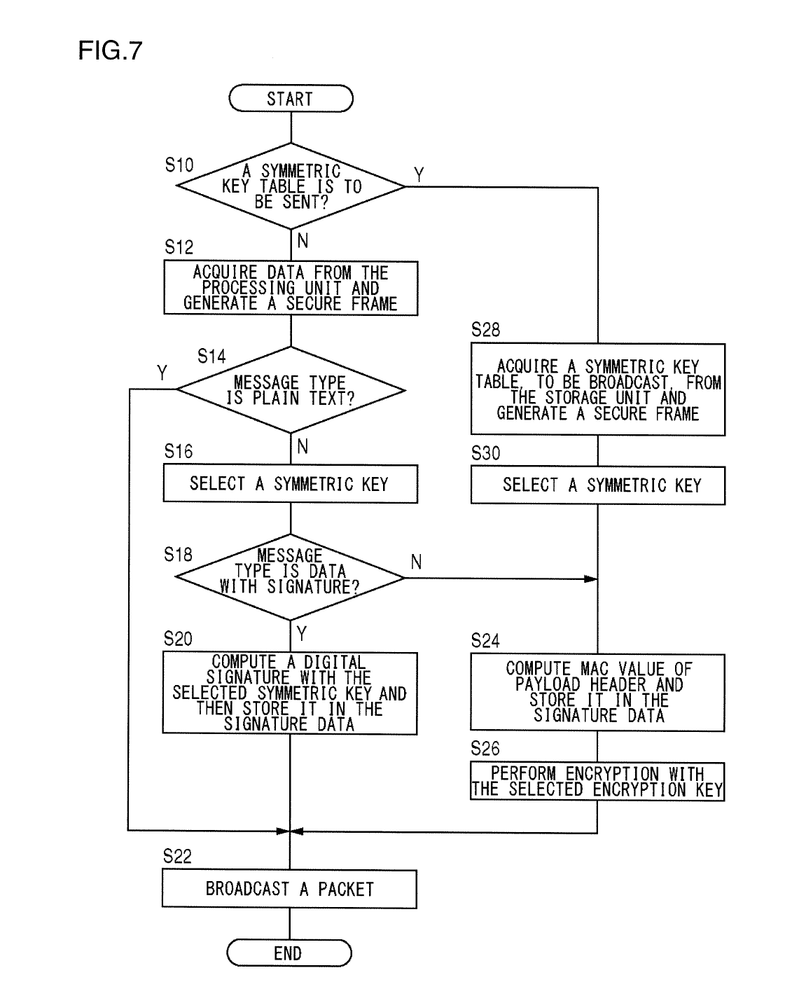

An operation regarding the transmitting/receiving of packets in the communication system 100 configured as above is now described. FIG. 7 is a flowchart showing a procedure for transmitting packets in the base station apparatus 10. If a symmetric key table is not to be transmitted (N of S10), the verification unit 40 will receive, from the processing unit 28, the data and the data format of the message type used to transmit the data. Then, a secure frame in which the received data is stored in the payload is generated (S12). At this time, the key ID and the signature are empty, and therefore “0” is stored in all of these, for instance. Then, if the data format of the message type is plaintext data (Y of S14), the secure frame will be directly broadcast as a packet via the MAC frame processing unit 56, the modem unit 54, the RF unit 52, and the antenna 50. If the data format of the message type is data with signature or encrypted data (N of S14), a symmetric key will be selected (S16). The symmetric key is selected randomly from the latest symmetric key table. As the symmetric key is selected, the table ID of the latest symmetric key table and the selected symmetric key ID are stored in the key ID of the secure frame. If the data type is data with signature after the data format of the message type is referenced again (Y of S18), the verification unit 40 will compute a digital signature for the payload header and the payload by the use of the selected symmetric key, at the encryption unit 42, and store the computed value in the signature of the secure frame (S20). Then, the secure frame with signature is broadcast as a packet via the MAC frame processing unit 56, the modem unit 54, the RF unit 52, and the antenna 50 (S22). If the data format of the message type is encrypted data (N of S18), the verification unit 40 will compute the MAC value of the payload at the encryption unit 42 and then the computed MAC value will be stored in the signature of the secure frame (S24). Then, the payload header and the signature are encrypted by the use of the selected symmetric key (S26). Then, the encrypted secure frame is broadcast as a packet via the MAC frame processing unit 56, the modem unit 54, the RF unit 52, and the antenna 50 (S22).

If, on the other hand, a symmetric key table is to be transmitted (Y of S10), the verification unit 40 will read the symmetric key table to be transmitted, from the storage unit 44 and generate a secure frame in which the read-out symmetric key table is stored in the payload (S28). Then, a symmetric key is randomly selected from a symmetric key table corresponding to the symmetric key table that is to be transmitted. As the symmetric key is selected, the table ID of the applicable symmetric key table and the selected symmetric key ID are stored in the key ID of the secure frame. Thereafter, the secure frame containing the encrypted symmetric key table is broadcast as a packet by way of Step S24 and Step S26 (S22).

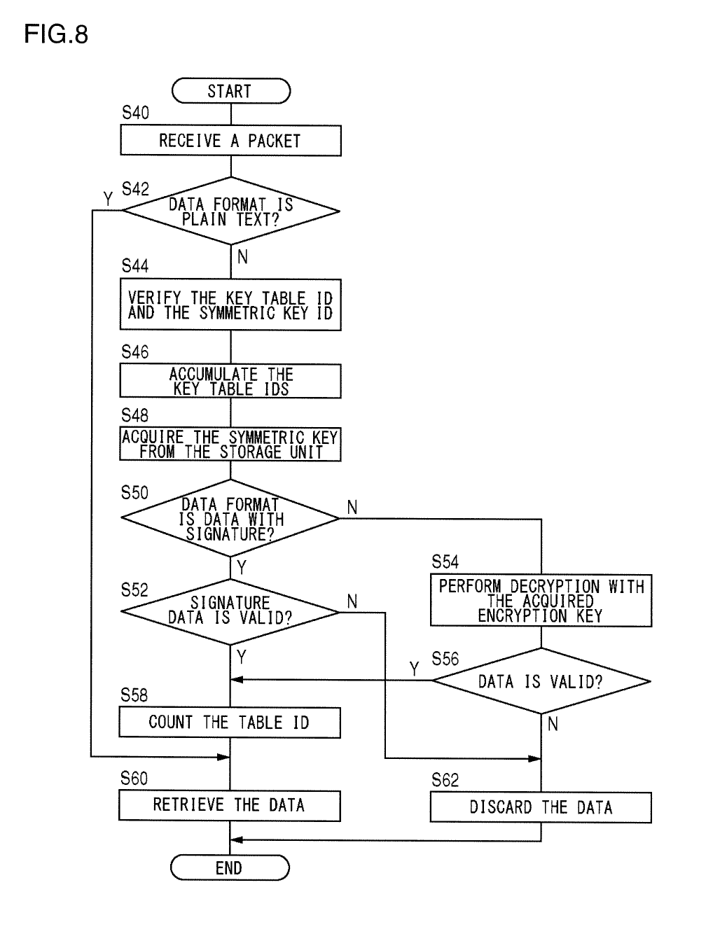

FIG. 8 is a flowchart showing a procedure for receiving packets in the base station apparatus 10. If the data format is not plain text (N of S42), namely if the data format is data with signature or encrypted data, the verification unit 40 will verify the table ID and the symmetric key ID (S44). The verification unit 40 stores up the table IDs (S46) and acquires a symmetric key from the storage unit 44 (S48). If the data format is data with signature (Y of S50) and if the signature data is valid (Y of S52), the verification unit 40 will count the table ID (S58) and retrieve the data (S60). If the signature data is not valid (N of S52), the verification unit 40 will discard the data (S62). If the data format is not data with signature (N of S50), namely if the data format is encrypted data, the verification unit 40 will decrypt with the acquired encryption key (S54). If the data is valid (Y of S56), the verification unit 40 will count the table ID (S58) and retrieve the data (S60). If the data is not valid (N of S56), the verification unit 40 will discard the data (S62). If the data format is plain text (Y of S42), the verification unit 40 will retrieve the data (S60).

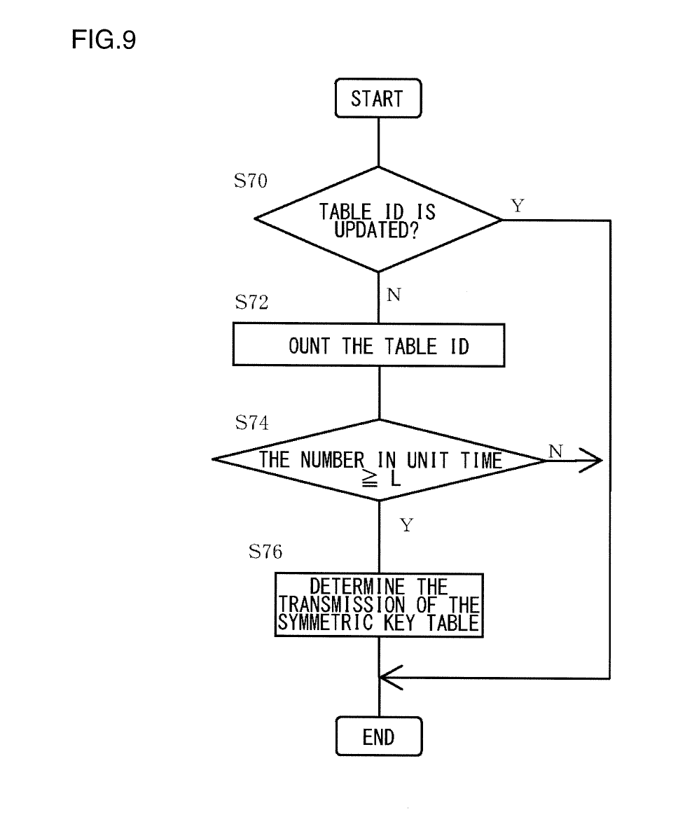

FIG. 9 is a flowchart showing a procedure for determining the broadcasting of a symmetric key table in the detector 46 of the base station apparatus 10. If a table ID is not updated (not the most current) (N of S70), the detector 46 will count this table ID (S72). If the number of detections in the unit time is L or above (Y of S74), the detector 46 will determine the transmission of the symmetric key table (S76). If a table ID is updated (most current) (Y of S70) or if the number of detections is less than L (N of S74), the processing will be terminated.

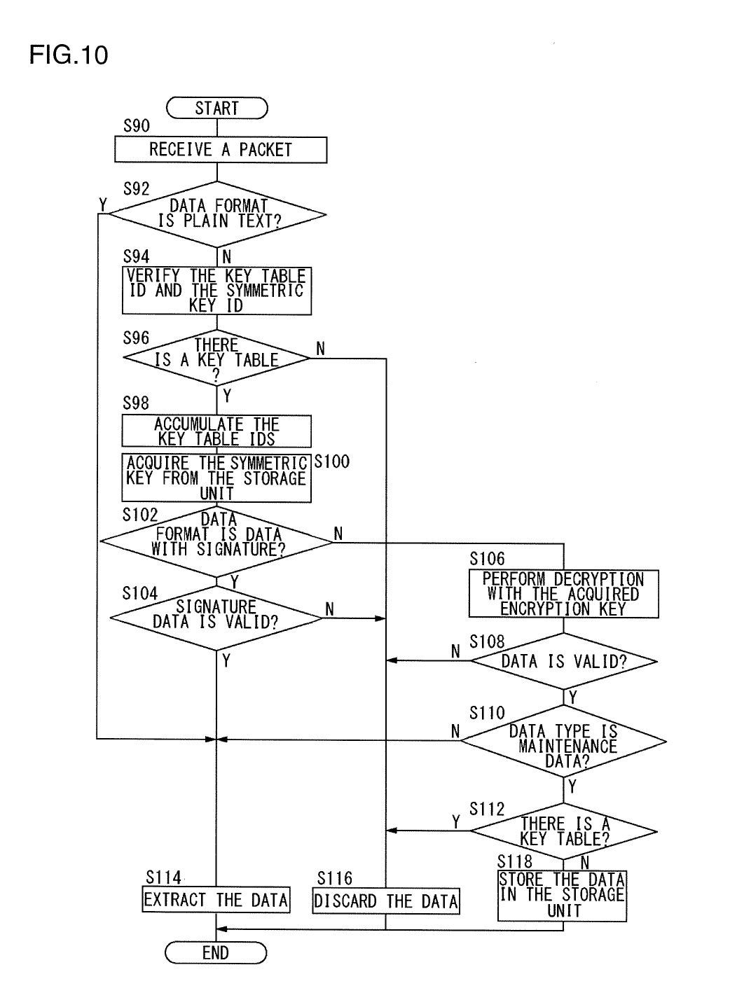

FIG. 10 is a flowchart showing a procedure for receiving packets in the terminal apparatus 14. The RF unit 52 and the modem unit 54 receive a packet (S90). If the data format is not plain text (N of S92), namely if the data format is data with signature or encrypted data, the verification unit 62 will verify the table ID and the symmetric key ID (S94). If there is a key table (Y of S96), the verification unit 62 will store up the table IDs (S98) and acquire a symmetric key from the storage unit 66 (S100). If the data format is data with signature (Y of S102) and if the signature data is valid (Y of S104), the verification unit 62 will extract the data (S114). If the signature data is not valid (N of S104), the verification unit 62 will discard the data (S116).

If the data format is not data with signature (N of S102), namely if the data format is encrypted data, the verification unit 62 will decrypt the data with the acquired encryption key (S106). If the data is valid (Y of S108) and if the data type is maintenance data (Y of S110) and if there is no key table (N of S112), the verification unit 62 will store the data in the storage unit 66 (S118). If the data is not valid (N of S104) or if the data is not valid (N of S108) or if there is a key table (Y of S112), the verification unit 62 will discard the data (S116). If the data type is not maintenance data (N of S110), the verification unit 62 will extract the data (S114).

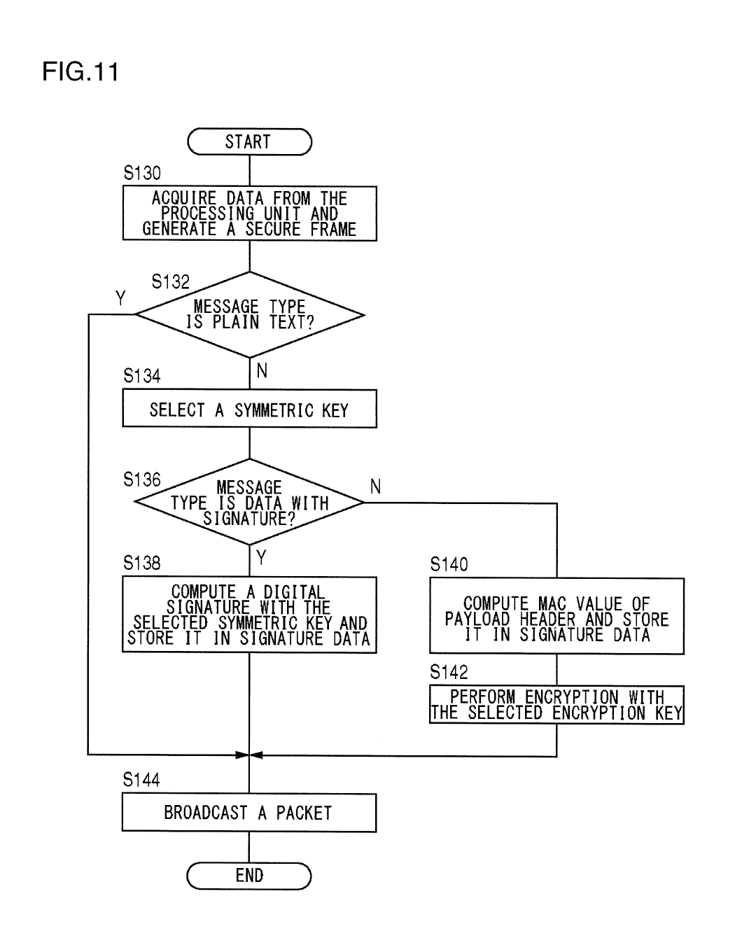

FIG. 11 is a flowchart showing a procedure for transmitting packets in the terminal apparatus 14. The verification unit 62 acquires the data from the processing unit and generates a secure frame (S130). If the message type is not plain text (N of S132), namely if the message type is data with signature or encrypted data, the verification unit 62 will select a symmetric key (S134). If the message type is data with signature (Y of S136), the verification unit 62 will compute a digital signature by the use of the selected symmetric key and then store it in the signature data (S138). The modem unit 54 and the RF unit 52 broadcast a packet (S144). If the message type is not data with signature (N of S136), namely if the message type is encrypted data, the verification unit 62 will compute a MAC value of the payload header and store the computed MAC value thereof in the signature data (S140) and the verification unit 62 will also perform encryption with the selected encryption key (S142). The modem unit 54 and the RF unit 52 broadcast a packet (S144). If the message type is plain text (Y of S132), the modem unit 54 and the RF unit 52 will broadcast the packet (S144).

By employing the exemplary embodiments of the present invention, if it is detected that a symmetric key table used in a terminal apparatus is an old version and if the number of detections is a predetermined number of times or above, a new symmetric key table will be transmitted and therefore the number of transmissions can be restricted. Also, since the number of transmissions is restricted, an increase in traffic can be suppressed. Also, since the traffic increase is suppressed, the symmetric key can be efficiently distributed in the broadcast communications. Also, if the number of terminal apparatuses that use the symmetric key of old version increases, a symmetric key table of the latest version will be broadcast and therefore the symmetric key table can be updated. Also, since the symmetric key of the latest version is used, the security can be improved.

Also, since a symmetric key is used to generate a digital signature, the processing amount can be reduced as compared with the case where a public key is used. Also, since the processing amount is reduced, the number of processable packets can be increased. Also, since a symmetric key is used to generate a digital signature, the transmission efficiency can be improved as compared with the case where a public key is used. Also, data such as positional information is not encrypted and therefore the processing amount can be reduced. On the other hand, the symmetric key table is encrypted, so that the security can be improved.

Modifications of the exemplary embodiments relate to a communication system that carries out not only an inter-vehicular communication between terminal apparatuses mounted on vehicles but also a road-to-vehicle communication from a base station apparatus installed in an intersection and the like to the terminal apparatuses. As the inter-vehicular communication, a terminal apparatus transmits, by broadcast, a packet in which the information such as the traveling speed and position of its vehicle is stored (note that the transmission of packet(s) by broadcast is hereinafter called “broadcasting”, “being broadcast” or “by broadcast” also). And the other terminal apparatuses receive the packets and recognize the approach or the like of the vehicle based on the data. As the road-to-vehicle communication, a base station apparatus broadcasts a packet in which the intersection information, the traffic jam information, the security information, and the like are stored. For simpler explanation, the information contained in the packet used for the inter-vehicular communication and the road-to-vehicle communication will be hereinafter generically referred to as “data”.

The intersection information includes information on conditions at an intersection such as the position of the intersection, images captured of the intersection, where the base station apparatus is installed, and positional information on vehicles at or near the intersection. A terminal apparatus displays the intersection information on a monitor, recognizes the conditions of vehicles at or near the intersection based on the intersection information, and conveys to a user the presence of other vehicles and pedestrians for the purpose of preventing collision due to a right turn or a left turn at a sudden encounter at the intersection and the like so as to prevent the accidents. The traffic jam information includes information concerning the congestion situation near the intersection, where the base station apparatus is installed, and the information concerning road repairing and accidents that have happened. Based on such information, how much the road ahead may be congested is conveyed to the user or any possible detour is presented thereto. The security information includes information concerning the protection of data such as provision of a symmetric key table. Its detail will be discussed later. Its detail will be discussed later.

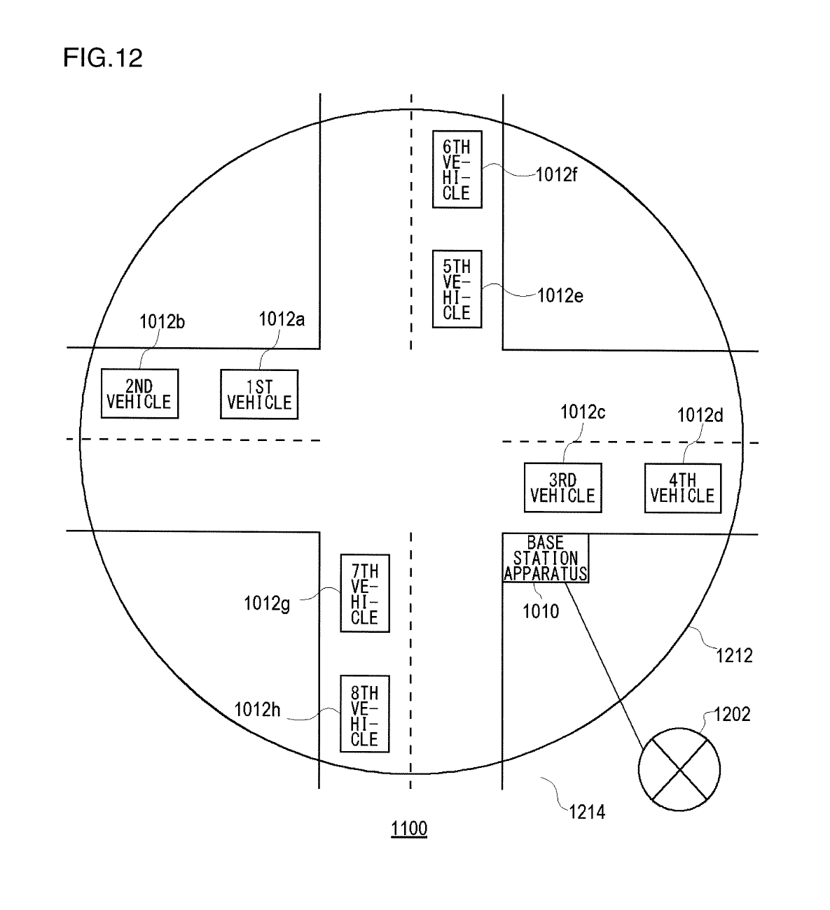

FIG. 12 shows a structure of a communication system 1100 according to a modification of an exemplary embodiment of the present invention. FIG. 12 corresponds to a case thereof at an intersection viewed from above. The communication system 1100 includes a base station apparatus 1010, a first vehicle 1012a, a second vehicle 1012b, a third vehicle 1012c, a fourth vehicle 1012d, a fifth vehicle 1012e, a sixth vehicle 1012f, a seventh vehicle 1012g, and an eighth vehicle 1012h, which are generically referred to as “vehicle 1012” or “vehicles 1012”, and a network 1202. The communication system 1100, the base station apparatus 1010, the vehicles 1012, and the network 1202 correspond respectively to the communication system 100, the base station apparatus 10, the vehicles 12, and the network 202 of FIG. 1. A description is given here centering around features different from those of FIG. 1. The communication system 1100 uses a digital signature (digital signature) in order to prevent the spoofing, use of a false identity and the like in the communications.

If only a single type of symmetric key is used in the communication system 1100, a malicious user may easily obtain the symmetric key. In order to cope with this, namely in order to reduce the risk of leakage of such a key, a plurality of symmetric keys are used. Thus, in the communication system 1100, a predetermined number of symmetric keys are gathered together into a single symmetric key table. Also, a plurality of symmetric key tables are also prepared, so that they are switched thereamong as necessary. A symmetric key is identified by a table ID by which to identify a symmetric key table and a symmetric key ID by which to identify the symmetric key in the identified table. An effective date/time (“NotBefore”) is defined in the symmetric key table. Thus, a symmetric key table, which is about to newly go into effect”, may be broadcast from the base station apparatus 1010 in the road-to-vehicle communication before the effective date/time. Or this symmetric key table may be recorded beforehand in a terminal apparatus, so that the symmetric key table can be shared between terminal apparatuses or between the base station apparatus 1010 and the terminal apparatus. Note that the symmetric key table is contained in the security information.

In the communication system 1100, the data whose validity is required, namely the data such as information on its vehicle in the inter-vehicle communication, intersection information and the traffic jam information in the road-to-vehicle communication, does not undergo encryption of data itself. Instead, an electronic signal is generated with a symmetric key, and a packet in which the digital signature has been appended to the data is broadcast. The packet contains a table ID and a symmetric key ID used for the generation of the digital signature. As defined as above, the spoofing or use of a false identity is prevented. Also, for the data for which the secrecy of information is required, namely the data such as security information in the road-to-vehicle communication, a packet in which the data itself has been encrypted is broadcast. The packet contains a table ID and a symmetric key ID used for the encryption. In this manner, the authenticity and security of data are ensured and, at the same time, an increase in the processing amount and degradation in transmission load are suppressed.

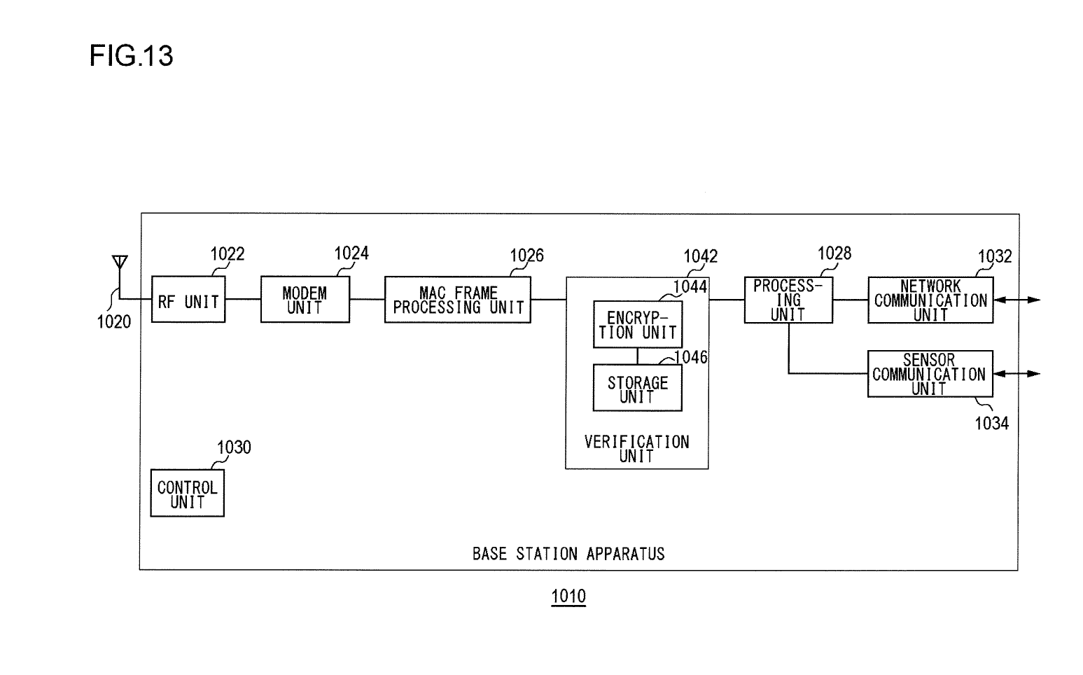

FIG. 13 shows a structure of the base station apparatus 1010. The base station apparatus 1010 includes an antenna 1020, an RF unit 1022, a modem unit 1024, a MAC frame processing unit 1026, a verification unit 1042, a processing unit 1028, a control unit 1030, a network communication unit 1032, and a sensor communication unit 1034. The verification unit 1042 includes an encryption unit 1044 and a storage unit 1046. The antenna 1020, the RF unit 1022, the modem unit 1024, the MAC frame processing unit 1026, the verification unit 1042, the processing unit 1028, the control unit 1030, the network communication unit 1032, and the sensor communication unit 1034 correspond respectively to the antenna 20, the RF unit 22, the modem unit 24, the MAC frame processing unit 26, the verification unit 40, the processing unit 28, the control unit 30, the network communication unit 32, and the sensor communication unit 34 of FIG. 2. A description is given here centering around features different from those of FIG. 2.

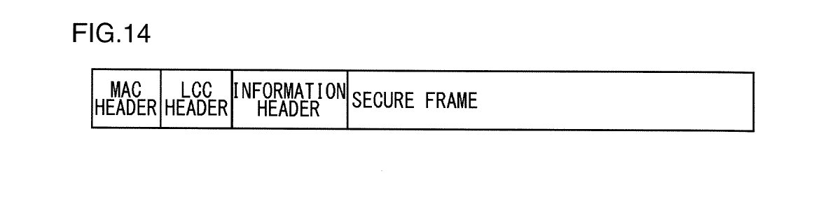

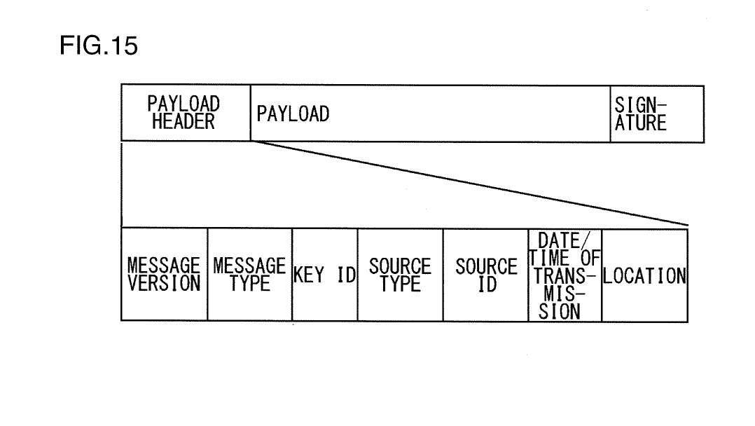

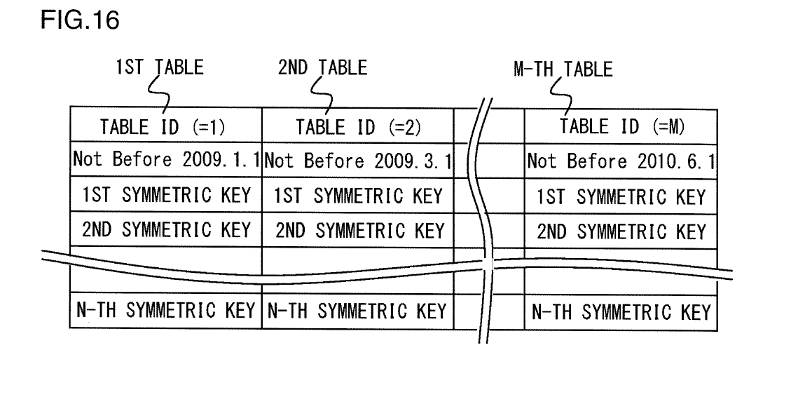

FIG. 14 shows a format of MAC frame stored in the packet defined in the communication system 1100. This is similar to FIG. 3 and therefore the description thereof is omitted here. FIG. 15 shows a format of secure frame stored defined in the communication system 1100. This is similar to FIG. 4 and therefore the description thereof is omitted here. FIG. 16 shows a data structure of a symmetric key table stored in the storage unit 1046. Here, “NotBefore” may not be provided at all. FIG. 16 is similar to FIG. 5 and therefore the description thereof is omitted here.

The storage unit 1046 further records the table ID of a symmetric key table which has been used in the received packet. The table IDs recorded are used to identify a table ID which is used most frequency in the packet received for each unit time. Thus, the arrangement may be such that some or all of those table IDs recorded are automatically discarded according to time lapse or the limitation set regarding the number of key tables storable in the storage unit 1046.

When the secure frame is to be generated, the verification unit 1042 extracts a symmetric key by referencing the storage unit 1046. “NotBefore” is defined in each symmetric key table, and the verification unit 1042 selects one of symmetric key tables, which are already effective, based on the present date and time. Where a plurality of symmetric key tables are already effective, the verification unit 1042 selects a symmetric key table whose “NotBefore” value is the maximum, namely whose effective date/time is the most recent. If the table ID of a symmetric key table corresponds to a symmetric key table whose effective date/time is old, a predetermined number of times in a predetermined period of time, the verification unit 1042 will use, for the purpose of generating a digital signature, the symmetric key table whose effective date/time is old, instead of the symmetric key table whose effective date/time is the most recent. If there is no “NotBefore” defined, a symmetric key table which is stored most recently will preferably be used.

Further, the verification unit 1042 generates a secure frame containing the symmetric key table stored in the storage unit 1046. The symmetric key table stored in the storage unit 1046 is to be broadcast before the effective date/time and will be broadcast after the effective date/time. Thereafter, this symmetric key table will be removed from a list of what is to be broadcast (a broadcasting list), when a symmetric key table whose effective date/time is set to a future (newer) date/time. The verification unit 1042 manages the respective symmetric key tables stored in the storage unit 1046 as to whether they are to be broadcast or not (whether they are in the broadcasting list or not). The verification unit 1042 selects a symmetric key table to which a table ID, indicating that said table is to be broadcast, is attached, and generates a secure frame in which the selected symmetric key table is stored. In this case, the message type is set to the encryption data. It is assumed herein that the symmetric key table used for encryption is a symmetric key table selected from among the symmetric key tables, stored in the storage unit 1046, whose effective date/time are earlier than the effective date/time of keys of the symmetric key table which is to be broadcast. The timing of the broadcasting may be arbitrary. However, the broadcasting timing after the effective date/time may be such that the broadcast is done while said symmetric key table is not being used after the packets from the surrounding terminal apparatuses 1014 have been received.

Note that another different symmetric key may be defined for use in broadcasting the symmetric key table. Also, encryption may be performed with a symmetric key sent from a terminal apparatus 1014 or a public key. In this case, the terminal apparatus 1014 capable of receiving the symmetric key table is limited to the terminal apparatus 1014 that has sent the key used for encryption.

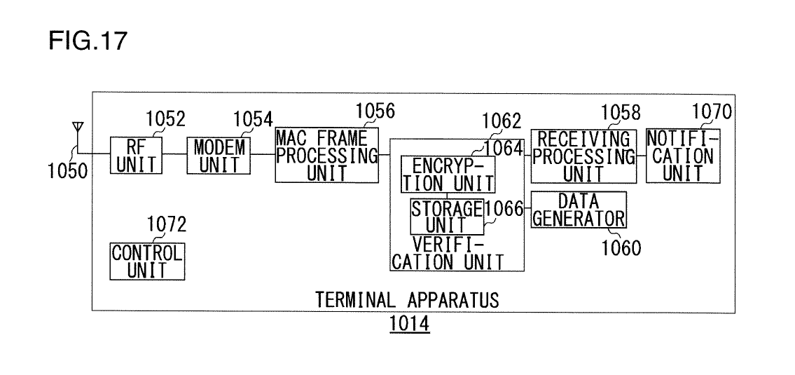

FIG. 17 shows a structure of a terminal apparatus 1014 mounted on a vehicle 1012. The terminal apparatus 1014 includes an antenna 1050, an RF unit 1052, a modem unit 1054, a MAC frame processing unit 1056, a receiving processing unit 1058, a data generator 1060, a verification unit 1062, a notification unit 1070, and a control unit 1072. The verification unit 1062 includes an encryption unit 1064 and a storage unit 1066. The antenna 1050, the RF unit 1052, the modem unit 1054, the MAC frame processing unit 1056, the verification unit 1062, the encryption unit 1064, and the storage unit 1066 perform the processings similar to those of the antenna 1020, the RF unit 1022, the modem unit 1024, the MAC frame processing unit 1026, the verification unit 1042, the encryption unit 1044, and the storage unit 1046 of FIG. 13, respectively. The receiving processing unit 1058, the data generator 1060, the notification unit 1070, and the control unit 1072 are similar to the receiving processing unit 58, the data generator 60, the notification unit 70, and the control unit 72, respectively. Thus, the description of the similar processings thereto is omitted here and a description is given centering around features different from those of FIG. 6.

When it is detected by the verification unit 1062 that a symmetric key, through which a digital signature attached to the received packet is generated, is contained in a symmetric key table unrecorded in the storage unit 1066, the notification unit 1070 conveys the detection result to the driver accordingly.

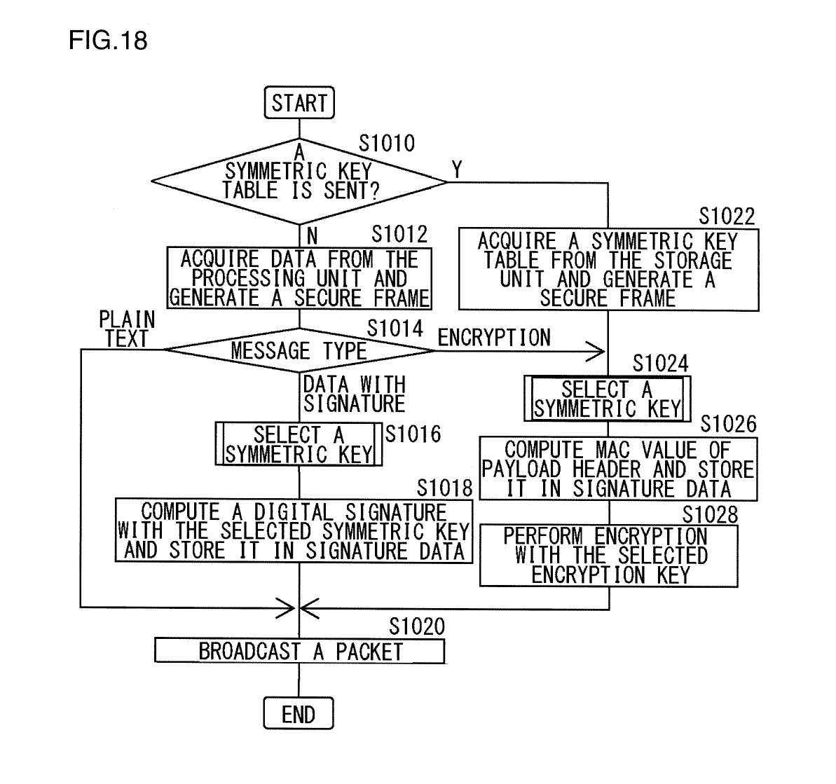

An operation regarding the transmitting/receiving of packets in the communication system 1100 configured as above is now described. FIG. 18 is a flowchart showing a procedure for transmitting packets in the base station apparatus 1010. If a symmetric key table is not to be transmitted (N of S1010), the verification unit 1042 will receive, from the processing unit 1028, the data and the message type used to transmit the data. Then, a secure frame in which the received data is stored in the payload is generated (S1012). At this time, the key ID and the signature are empty, and therefore “0” is stored in all of these, for instance. Then, if the data format of the message type is plaintext data (“plain text” of S1014), the secure frame will be directly broadcast as a packet via the MAC frame processing unit 1026, the modem unit 1024, the RF unit 1022, and the antenna 1020 (S1020). If the message type is data with signature (“data with signature” of S1014), a symmetric key will be selected (S1016). As the symmetric key is selected, the table ID of the selected symmetric key and the symmetric key ID are stored in the key ID of the secure frame.

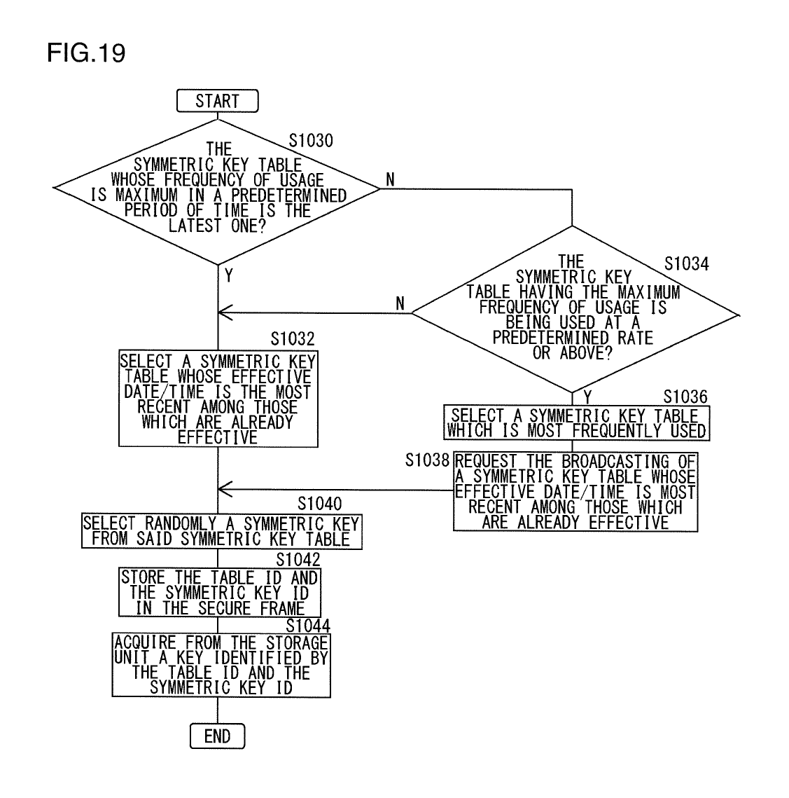

FIG. 19 is a flowchart showing a procedure for selecting a symmetric key in the base station apparatus 1010. If the message type is data with signature or encrypted data, the verification unit 1042 will select one of symmetric key tables, which are recorded in the storage unit 1046 and are already effective, and further selects one key from within the selected symmetric key table. “NotBefore” is defined in each symmetric key table, and the verification unit 1042 selects one of symmetric key tables, which are already effective, based on the present date and time. Recorded are the table IDs of symmetric key tables that contain symmetric keys used in the packet received from the terminal apparatus 14 recorded in the storage unit 1046. Based on this record, the verification unit 1042 verifies a symmetric key table that is most frequently used in a predetermined unit time (S1030). If the most frequently used symmetric key table is the latest symmetric key table, that is, a symmetric key table whose effective date/time is the latest in the symmetric key tables which are already effective (Y of S1030), the latest symmetric key table will be selected (S1032). If the most frequently used symmetric key table is not the latest symmetric key table (N of S1030), it will be verified whether the usage frequency of the symmetric key table exceeds a predetermined rate or not (S1034). If the usage frequency thereof does not exceed the predetermined rate (N of S1034), the latest symmetric key table will be selected (S1032). If the usage frequency thereof exceeds the predetermined rate (Y of S1034), the most frequently used symmetric key table will be selected (S1036). Then, a request is made for the broadcasting of the latest symmetric key table among those that are already effective (S1038). Since it is estimated that many of the surrounding terminal apparatuses 1014 haven't had the latest symmetric key table which are already effective, this latest symmetric key table is broadcasted purposely. As a common table to be used is selected, the verification unit 1042 randomly selects a symmetric key from within the selected key table (S1040). Then the table ID of the selected symmetric key table and the symmetric key ID of the selected symmetric key are stored in the key ID of the secure frame (S1042), and the selected key is read from the storage unit 1046 (S1044).

Now, refer back to FIG. 18. The verification unit 1042 computes a digital signature for the payload header and the payload by the use of the selected symmetric key, at the encryption unit 1044, and stores the computed value in the signature of the secure frame (S1018). Then, the secure frame with signature is broadcast as a packet via the MAC frame processing unit 1026, the modem unit 1024, the RF unit 1022, and the antenna 1020 (S1020). If the message type is encrypted data (“encryption” of S1014), a symmetric key will be selected (S1024). Selecting the symmetric key is similar to Step S1016 and therefore the description thereof is omitted here. As the symmetric key is selected, the verification unit 1042 will compute the MAC value of the payload at the encryption unit 1044 and then the computed MAC value will be stored in the signature of the secure frame (S1026). Then, the payload header and the signature are encrypted by the use of the selected symmetric key (S1028). Then, the encrypted secure frame is broadcast as a packet via the MAC frame processing unit 1026, the modem unit 1024, the RF unit 1022, and the antenna 1020 (S1020). If, on the other hand, a symmetric key table is to be transmitted (Y of S1010), the verification unit 1042 will read the symmetric key table to be transmitted, from the storage unit 1046 and generate a secure frame in which the read-out symmetric key table is stored in the payload (S1022). Thereafter, similarly to the case where the message type is encrypted data, the secure frame containing the encrypted symmetric key table is broadcasted as a packet by way of Step S1024, Step S1026, and Step S1028 (S1020).

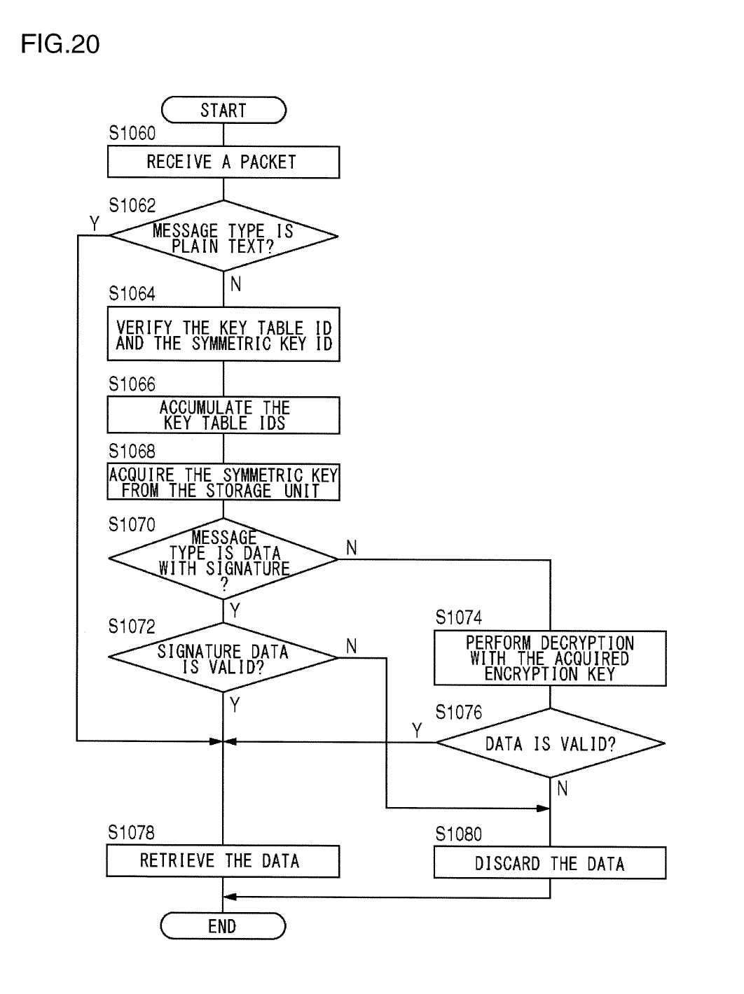

FIG. 20 is a flowchart showing a procedure for receiving packets in the base station apparatus 1010. The antenna 1020, the RF unit 1022, and the modem unit 1024 receive the packet (S1060). If the message type is data with signature or encrypted data (N of S1062), the verification unit 1042 will verify the table ID and the symmetric key ID (S1064). The storage unit 1046 stores up the table IDs (S1066). The verification unit 1042 acquires a symmetric key from the storage unit 1046 (S1068). If the message type is data with signature (Y of S1070) and the signature data is valid (Y of S1072), the verification unit 1042 will retrieve the data (S1078). If, on the other hand, the message type is encrypted data (N of S1070), the verification unit 1042 will decrypt the data with the acquired encryption key (S1074). If the data is valid (Y of S1076), the verification unit 1042 will retrieve the data (S1078). If the message type is plain text (Y of S1062), the verification unit 1042 will retrieve the data (S1078). If the data with signature is not valid (N of S1072) or if the data is not valid (N of S1076), the verification unit 1042 will discard the data (S1080).

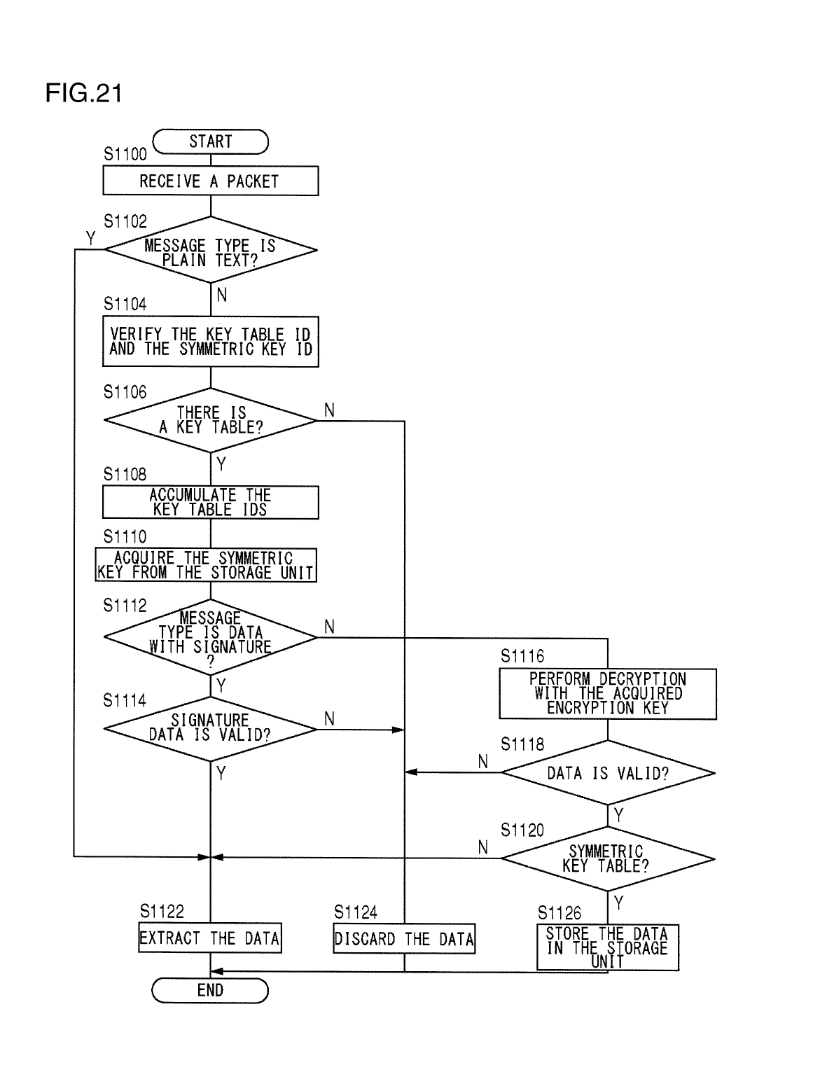

FIG. 21 is a flowchart showing a procedure for receiving packets in the terminal apparatus 1014. The antenna 1050, the RF unit 1052, and the modem unit 1054 receive the packet (S1100). If the message type is data with signature (N of S1102), the verification unit 1062 will verify the table ID and the symmetric key ID (S1104). If the storage unit 1066 has a key table (Y of S1106), the storage unit 1066 will store up the table IDs (S1108). The verification unit 1062 acquires a symmetric key from the storage unit 1066 (S1110). If the message type is data with signature (Y of S1112) and the signature data is valid (Y of S1114), the verification unit 1062 will retrieve the data (S1122).

If, on the other hand, the message type is encrypted data (N of S1112), the verification unit 1062 will decrypt the data with the acquired encryption key (S1116). If the data is valid (Y of S1118) and if there is no symmetric key table (N of S1120), the verification unit 1062 will extract the data (S1122). If the message type is plain text (Y of S1102), the verification unit 1062 will retrieve the data (S1122). If the storage unit 1066 does not have any key table (N of S1106) or if the signature data is not valid (N of S1114) or if the data is not valid (N of S1118), the verification unit 1062 will discard the data (S1124). If there is a symmetric key table (Y of S1120), the verification unit 1062 will store it in the storage unit 1066.

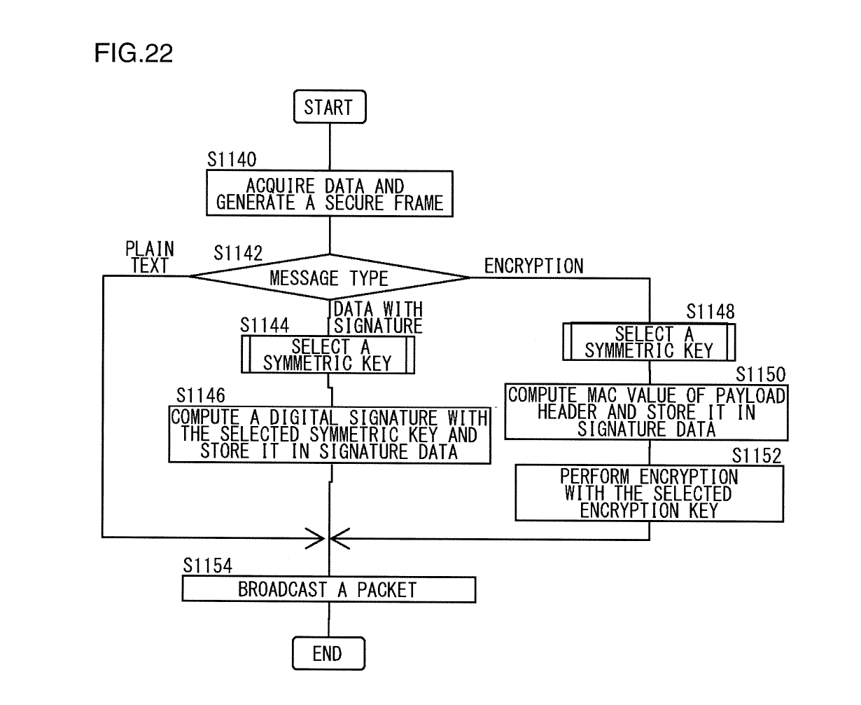

FIG. 22 is a flowchart showing a procedure for transmitting packets in the terminal apparatus 1014. The verification unit 1062 acquires the data and generates a secure frame (S1140). If the message type is data with signature (“data with signature” of S1142), the verification unit 1062 will select a symmetric key (S1144) and compute a digital signature by the use of the selected symmetric key and then store it in the signature data (S1146). Then, the modem unit 1054, the RF unit 1052, and the antenna 1050 broadcast the packet (S1154). If the message type is encrypted data (“encryption” of S1142), the verification unit 1062 will select a symmetric key (S1148), and will compute a MAC value of the payload header and store the computed MAC value thereof in the signature data (S1150). The verification unit 1062 performs encryption with the selected encryption key (S1152), and the modem unit 1054, the RF unit 1052 and the antenna 1050 broadcast the packet (S1154). If the message type is plain text (“plain text” of S1142), the modem unit 1054, the RF unit 1052 and the antenna 1050 will broadcast the packet (S1154).

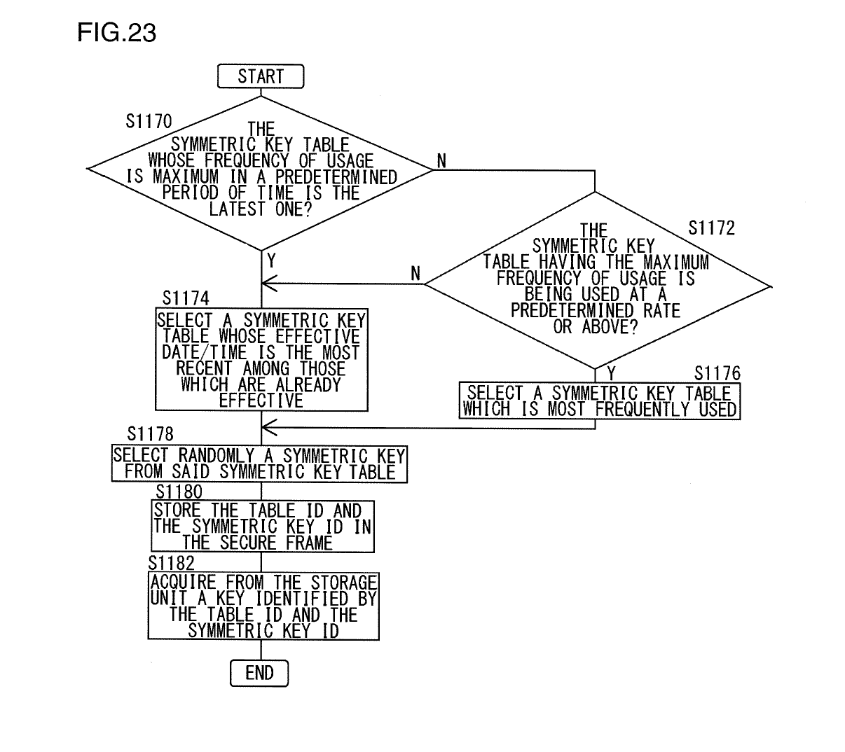

FIG. 23 is a flowchart showing a procedure for selecting a symmetric key in the terminal apparatus 1014. If the most frequently used symmetric key table is the latest in a predetermined period of time (Y of S1170) or if the most frequently used symmetric key table is not used at a predetermined rate or above (N of S1172) even though the most frequently used symmetric key table is not the latest in a predetermined period of time (N of S1170), the verification unit 1062 will select a symmetric key table whose effective date/time is most current among those which are already effective (S1174). If the most frequently used symmetric key table is used at the predetermined rate or above (Y of S1172), the verification unit 1062 will select the most frequently used symmetric key table (S1176). The verification unit 1062 randomly selects a symmetric key from this key table (S1178), and stores the table ID and the symmetric key ID in the secure frame. The verification unit 1062 acquires from the storage unit 1066 a key identified by the table ID and the symmetric key ID (S1182).

By employing this modification, a symmetric key table whose effective date/time is more recent is preferentially used, so that the security can be ensured. Also, where used are many symmetric key tables whose effective dates/times are old, a symmetric key table whose effective date/time is older is used. Thus, a symmetric key which is shared among many terminal apparatuses can be used. Also, symmetric key tables whose effective dates/times are different from each other are used. Thus, where the broadcasting communication is in use, a shared symmetric key can be used while the security is ensured.

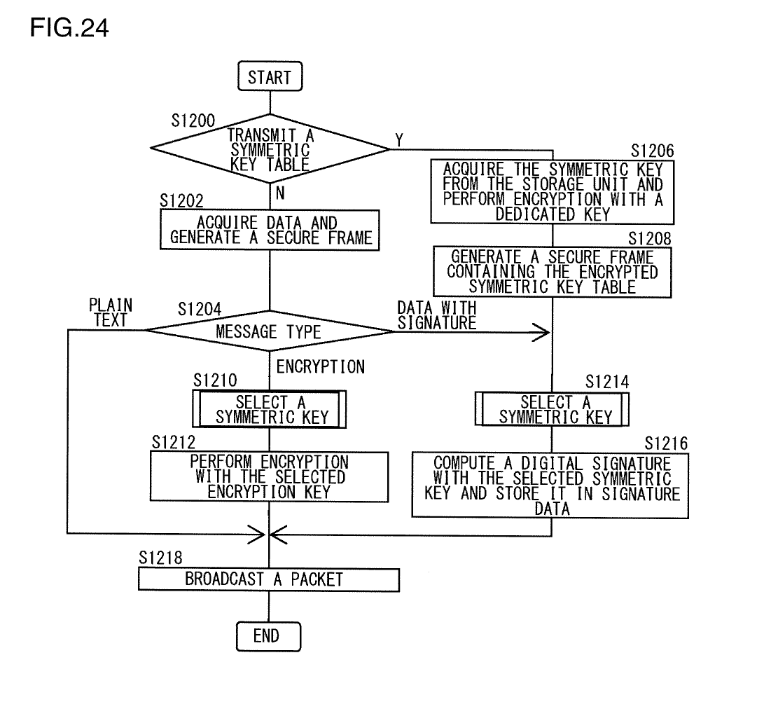

FIG. 24 is a flowchart showing another procedure for transmitting packets in the base station apparatus 1010. The procedure for transmitting a symmetric key table from the base station apparatus 1010 to the terminal apparatus 1014 is different from the previously described procedure. The symmetric key table is encrypted with a transmitting key, and is transmitted in such a manner that the message type is data with signature. If the symmetric key table is not to be transmitted (N of S1200), the verification unit 1042 will receive from the processing unit 1028 the data and the message type of the data. Then a secure frame in which the received data is stored in the payload is generated (S1202). Then, if the message type is plain text (“plain text” of S1204), the secure frame is broadcast as it is as a packet via the MAC frame processing unit 1026, the modem unit 1024, the RF unit 1022, and the antenna 1020 (S1218). If the message type is data with signature (“data with signature” of S1204), a symmetric key will be selected (S1214). The verification unit 1042 computes a digital signature for the payload header and the payload by the use of the selected symmetric key, at the encryption unit 1044, and stores the computed value in the signature of the secure frame (S1216). Then, the secure frame with signature is broadcast as a packet via the MAC frame processing unit 1026, the modem unit 1024, the RF unit 1022, and the antenna 1020 (S1218).

If the message type is encrypted data (“encryption” of S1204), a symmetric key will be selected (S1210). The verification unit 1042 encrypts the payload header and the signature by the use of the selected symmetric key (S1212). Then, the encrypted secure frame is broadcast as a packet via the MAC frame processing unit 1026, the modem unit 1024, the RF unit 1022, and the antenna 1020 (S1218). If, on the other hand, a symmetric key table is to be transmitted (Y of S1200), the verification unit 1042 will read the symmetric key table to be transmitted, from the storage unit 1046 and encrypt the read-out symmetric key table with a dedicated key (S1206). The verification unit 1042 generates a secure frame containing the encrypted symmetric key table (S1208). Thereafter, similarly to the case where the message type is encrypted data, the secure frame is broadcasted as a packet by way of Step S1214 and Step S1216 (S1218).

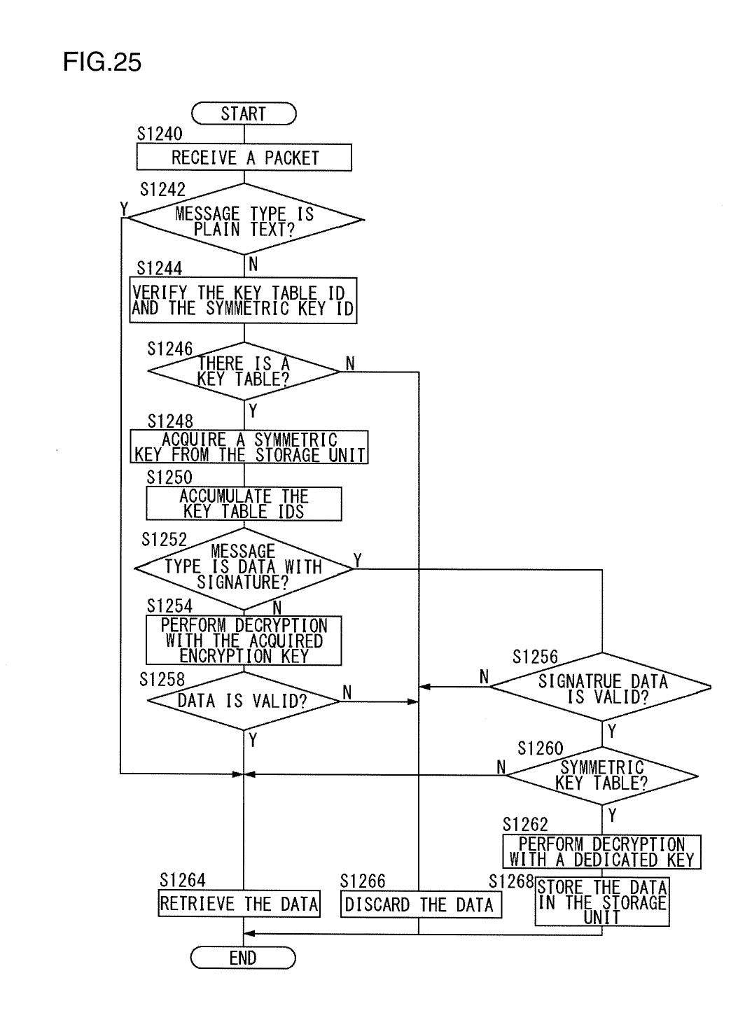

FIG. 25 is a flowchart showing another procedure for receiving packets in the terminal apparatus 1014. The antenna 1050, the RF unit 1052, and the modem unit 1054 receive the packet (S1240). If the message type is data with signature or encrypted data (N of S1242), the verification unit 1062 will verify the table ID and the symmetric key ID (S1244). If the storage unit 1066 has a key table (Y of S1246), the verification unit 1062 will acquire a symmetric key from the storage unit 1066 (S1248). The storage unit 1066 stores up the table IDs (S1250). If the message type is encrypted data (N of S1252), the verification unit 1062 will decrypt the data with the acquired encryption key (S1254). If the data is valid (Y of S1258), the verification unit 1062 will retrieve the data (S1264). If the data is not valid (N of S1258), the verification unit 1062 will discard the data (S1266). If the message type is data with signature (Y of S1252), if the signature data is valid (Y of S1256), and if there is a symmetric key table (Y of S1260), the verification unit 1062 will perform decryption with the dedicated encryption key (S1262) and store the decrypted data in the storage unit 1066 (S1268). If the signature data is not valid (N of S1256), the verification unit 1062 will discard the data (S1266). If there is no symmetric key table (N of S1260), the verification unit 1062 will retrieve the data (S1264). If the message type is a plain text (Y of S1242), the verification unit 1062 will retrieve the data (S1264). If there is no key table (N of S1246), the verification unit 1062 will discard the data (S1266).

By employing this modification, a symmetric key is used to compute the value of a digital signature, so that the processing amount can be reduced as compared with the case where a public key is used. Also, since the processing amount is reduced, the number of processable packets can be increased. Also, since a symmetric key is used to compute the value of a digital signature, the transmission efficiency can be improved as compared with the case where a public key is used. Also, data such as positional information is not encrypted and therefore the processing amount can be reduced. On the other hand, the symmetric key table is encrypted, so that the security can be improved. Also, where the broadcasting communication is in use, a common encrypted key can be used while the security is ensured.

The present invention has been described based on the exemplary embodiments. The exemplary embodiments are intended to be illustrative only, and it is understood by those skilled in the art that various modifications to constituting elements and processes as well as arbitrary combinations thereof could be further developed and that such modifications and combinations are also within the scope of the present invention.

In the exemplary embodiment of the present invention, when the detector 46 performs the detection processing for each table of the symmetric key tables and when the number of detections becomes a predetermined number or a predetermined rate or above, the latest symmetric key table in use that is effective is broadcast as a packet. However, this should not be considered as limiting and, for example, another symmetric key table that is next-newer than the symmetric key table to be detected, may be broadcast as the packet.

In the exemplary embodiments of the present invention, the communication system 100 sets the effective dates/times and the periods of validity in the symmetric key tables. However, this should not be considered as limiting and, for example, no effective date/time and period of validity may be set. In such a case, the base station apparatus 10 and the terminal apparatuses 14 always use the latest symmetric key table. By employing this modification, the size of common tables can be reduced.

Also, the terminal apparatus 14 may decrypt and verify the data with all of the symmetric key tables stored, when the packet is received. The terminal apparatus 14 conveys the result to an application. For example, the results conveyed to the application may include the fact that the verification has been successful, the fact that verification has been successful with an old symmetric key table, the fact that the verification has failed, and so forth.

In the exemplary embodiments of the present invention, the base station apparatus 10 transmits the symmetric key table. However, this should not be considered as limiting and, for example, the base station apparatus 10 may not transmit the symmetric key table at all. In such a case, a base station apparatus for use in transmitting the symmetric key tables may be provided separately from said base station apparatus 10.

In the exemplary embodiment of the present invention, when the table ID received from the verification unit 40 is older than the table ID of the latest symmetric key table stored in the storage unit 44, the detector 46 counts the number of detections. However, this should not be considered as limiting and, for example, the detector 46 may further perform the detection processing for each version of the symmetric key tables. In such a case, even if the version of the symmetric key table, whose number of detections is a predetermined number or above, is older than the version of the symmetric key table stored in the storage unit 44 by two or more generations, the MAC frame processing unit 26 may generate a packet in which the latest version of symmetric key table is stored. By employing this modification, only the latest version of symmetric key table is transmitted, so that the traffic amount can be reduced.

The features and characteristics of the present invention described in the exemplary embodiments may be defined by the following Item 1 and Item 2:

### (Item 1)

A communication apparatus including:

a storage unit configured to store a first symmetric key table and a second symmetric key table, wherein the first symmetric key table lists a plurality of symmetric keys usable in communication, and the second symmetric key table has a newer effective date/time than the effective date/time of the first symmetric key table;

a processing unit configured to produce a digital signature by use of a symmetric key included in the second symmetric key table stored in the storage unit and to generate a packet to which the digital signature is attached; and

a communication unit configured to broadcast the packet generated by the processing unit,

wherein the communication unit receives packets broadcasted from the other communication apparatuses, and

wherein the processing unit examines whether the symmetric key through which the digital signature attached to the packet received by the communication unit is generated is contained in the first symmetric key table or not, and

when the symmetric key contained in the first symmetric key table is detected a predetermined number of times or more in a predetermined period of time, the first symmetric key table instead of the second symmetric key table is used to produce the digital signature.

### (Item 2)

A communication apparatus according to Item 1, further including a notification unit configured to convey to a user to the effect that the symmetric key through which the digital signature attached to the packet received by the communication unit is generated is contained in a symmetric key table unrecorded in the storage unit, when it is detected by the processing unit that said symmetric key is contained in the symmetric key table unrecorded in the storage unit.

What is claimed is:

1. A base station apparatus for controlling communications between terminal apparatuses each of which is to broadcast a packet to which a digital signature generated by a symmetric key in a symmetric key cryptosystem is appended, the base station apparatus comprising:
a storage unit configured to store a symmetric key table that indicates a plurality of kinds of symmetric keys usable for the communications between the terminal apparatuses;
a receiver configured to receive the packet from a terminal apparatus;
a verification unit configured to verify a version of the symmetric key table containing a symmetric key by which to generate the digital signature appended to the packet received by said receiver;
a detector configured to perform detection processing of detecting that the version of the symmetric key table verified by said verification unit is older than the version of the symmetric key table stored in the storage unit;
a generator configured to generate a packet that stores the symmetric key table stored in the storage unit, when the number of detections by said detector is a predetermined number or above in a unit time; and
a broadcasting unit configured to broadcast the packet generated by said generator.

2. A base station apparatus according to claim 1, wherein said detector performs the detection processing for each of versions of the symmetric key table,
wherein even when the version of the symmetric key table, whose number of detections is the predetermined number or above, is older than the version of the symmetric key table stored in the storage unit by two or more generations, said generator generates the packet that stores the symmetric key table stored in the storage unit.

3. A base station apparatus according to claim 1, wherein, when the number of detections in said detector is the predetermined number or above in the unit time, said generator generates the packet in a manner such that the symmetric key table is encrypted by a symmetric key of the symmetric key table whose version has been detected by said detector.

4. A base station apparatus according to claim 1, wherein, when data format of message type is data with signature, said generator generates the digital signature at least for payload by use of the symmetric key, and generates the packet in such a manner as to contain the payload and the digital signature.
